(19) United States
(12) Patent Application Publication
(10) Pub. No.: US 2026/0353440 A1
(43) Pub. Date: Nov. 5, 2026

(54) CHANNEL OCCUPANCY TIME SHARING IN UNLICENSED SPECTRUM

(71) Applicant: QUALCOMM Incorporated, San Diego, CA (US)

(72) Inventors: Giovanni CHISCI, San Diego, CA (US); Stelios STEFANATOS, San Diego, CA (US); Chih-Hao LIU, San Diego, CA (US); Jing SUN, San Diego, CA (US); Xiaoxia ZHANG, San Diego, CA (US)

(21) Appl. No.: 19/099,865

(22) PCT Filed: Sep. 26, 2023
(86) PCT No.: PCT/US2023/033754

§ 371 Date: Jan. 30, 2025

(30) Foreign Application Priority Data
Sep. 30, 2022 (GR) 20220100803

(51) Int. Cl. H04W 74/0808; H04W 72/25; H04W 74/08

(52) U.S. Cl. CPC H04W 74/0808; H04W 72/25; H04W 74/0866

(57) ABSTRACT

Wireless communications systems, apparatuses, and methods are provided. A user equipment (UE) may include a memory, a transceiver, and one or more processors coupled to the memory and the transceiver. The memory includes instructions executable by the one or more processors individually or collectively to cause the UE to perform a listen-before-talk (LBT) procedure, acquire, based on the LBT procedure being successful, a channel occupancy time (COT), transmit, to a second UE during the COT, a sidelink message for informing the second UE of a shared portion of the COT, acquire a first transmission starting point of one or more transmission starting points within a remaining portion of the COT, and transmit, within the COT after the acquiring of the first transmission starting point, a sidelink communication.

### CROSS-REFERENCE TO A RELATED APPLICATION

The present application claims priority to and the benefit of Greek Patent Application No. 20220100803, filed Sep. 30, 2022, the disclosure of which is referenced herein in its entirety as fully set forth below and for all applicable purposes.

### TECHNICAL FIELD

Aspects of the present disclosure relate generally to wireless communication systems, and more particularly, to communications within new radio-unlicensed (NR-U) operations. Some features may enable and provide improved communications, including channel occupancy time sharing for NR-U sidelink communications.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first sidelink user equipment (UE) may include performing a listen-before-talk (LBT) procedure; acquiring, based on the LBT procedure being successful, a channel occupancy time (COT); transmitting, to a second UE during the COT, COT sharing information for sharing the COT with the second UE; acquiring a first transmission starting point of one or more transmission starting points within a sharing portion of the COT; and transmitting, within the COT after the acquiring of the first transmission starting point, a sidelink communication.

In an additional aspect of the disclosure, a method of wireless communication performed by a first sidelink user equipment (UE) may include performing a listen-before-talk (LBT) procedure; acquiring, based on the LBT procedure being successful, a channel occupancy time (COT); transmitting, to a second UE during the COT, COT sharing information for sharing the COT with the second UE; transmitting, to the second UE during the COT, a COT reclaiming signal indicating an end of the sharing of the COT; and transmitting, after the end of the sharing of the COT, a sidelink communication in a remaining portion of the COT.

In an additional aspect of the disclosure, a method of wireless communication performed by a first sidelink user equipment (UE) may include receiving, from a second UE, a sidelink message indicating a shared channel occupancy time (COT) and one or more transmission starting points in the COT; and attempting a transmission of a sidelink communication at a first transmission starting point of the one or more transmission starting points, wherein the attempting the transmission is based on a reservation status of the first transmission starting point.

In an additional aspect of the disclosure, a first sidelink user equipment (UE) may include a memory; a transceiver; and at least one processor coupled to the memory and the transceiver, wherein the first sidelink UE is configured to perform a listen-before-talk (LBT) procedure; acquire, based on the LBT procedure being successful, a channel occupancy time (COT); transmit, to a second UE during the COT, COT sharing information for sharing the COT with the second UE; acquire a first transmission starting point of one or more transmission starting points within a sharing portion of the COT; and transmit, within the COT after the acquiring of the first transmission starting point, a sidelink communication.

In an additional aspect of the disclosure, a first sidelink user equipment (UE) may include a memory; a transceiver; and at least one processor coupled to the memory and the transceiver, wherein the first sidelink UE is configured to perform a listen-before-talk (LBT) procedure; acquire, based on the LBT procedure being successful, a channel occupancy time (COT); transmit, to a second UE during the COT, COT sharing information for sharing the COT with the second UE; transmit, to the second UE during the COT, a COT reclaiming signal indicating an end of the sharing of the COT; and transmit, after the end of the sharing of the COT, a sidelink communication in a remaining portion of the COT.

In an additional aspect of the disclosure, a first sidelink user equipment (UE) may include a memory; a transceiver; and at least one processor coupled to the memory and the transceiver, wherein the first sidelink UE is configured to receive, from a second UE, a sidelink message indicating a shared channel occupancy time (COT) and one or more transmission starting points in the COT; and attempt a transmission of a sidelink communication at a first transmission starting point of the one or more transmission starting points, wherein the attempting the transmission is based on a reservation status of the first transmission starting point.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates an example wireless communication network that supports channel occupancy time structure information (COT-SI) indication for NR-U sidelink operations according to some aspects of the present disclosure.

FIG. 4 illustrates an example sidelink communication according to some aspects of the present disclosure.

FIG. 5 illustrates an example COT sharing between sidelink UEs according to some aspects of the present disclosure.

FIG. 6 illustrates examples of sidelink slots in COT sharing in unlicensed spectrum according to some aspects of the present disclosure.

FIG. 7 illustrates an example of transmission starting points in COT sharing between sidelink UEs according to some aspects of the present disclosure.

FIG. 8 illustrates an example COT reclaiming signal in sidelink communication according to some aspects of the present disclosure.

FIGS. 9A and 9B are signaling diagrams of example sidelink communications according to some aspects of the present disclosure.

FIG. 10 is a block diagram of an exemplary user equipment (UE) according to some aspects of the present disclosure.

FIG. 11 is a block diagram of an exemplary network unit according to some aspects of the present disclosure.

FIG. 12 is a flow diagram of a communication method according to some aspects of the present disclosure.

FIG. 13 is a flow diagram of a communication method according to some aspects of the present disclosure.

FIG. 14 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1M nodes/km2), ultra-low complexity (e.g., ~10 s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 ms), and users with wide ranges of mobility or lack thereof; and (3) with enhanced mobile broadband including extreme high capacity (e.g., ~10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHZ, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannels in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

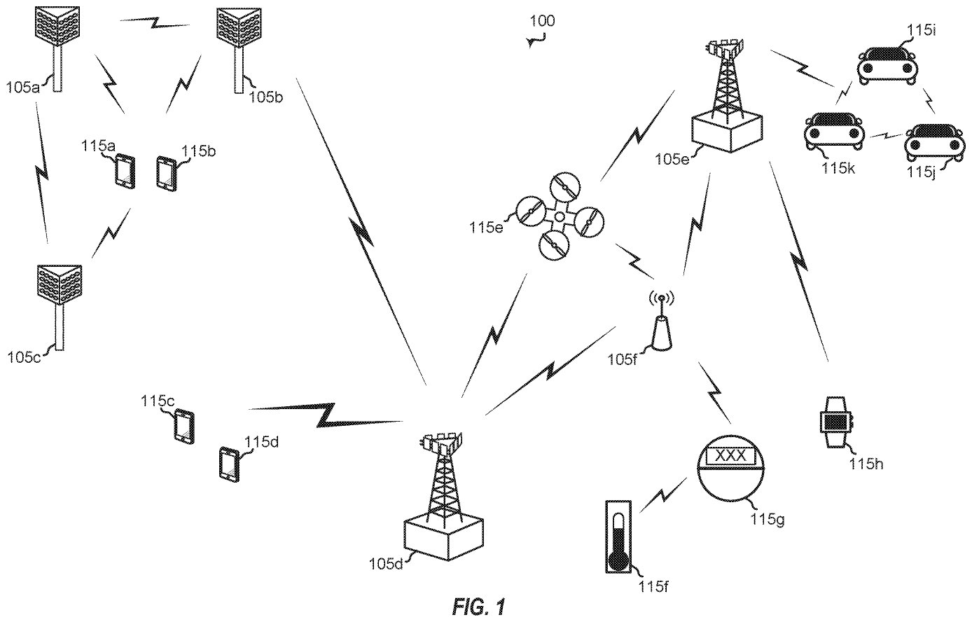

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices.

The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IOT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

Two types of channel access procedures for NR-U are available (e.g., type 1 and type 2). In a type 1 channel access procedure, a wireless device (e.g., gNB or UE) performs the channel access procedure in a time duration spanned by a random number of sensing slots to determine or find an idle channel before transmission. In a type 2 channel access procedure, a wireless device (e.g., gNB or UE) performs the channel access procedure in a time duration spanned by a deterministic number of sensing slots to determine an available (e.g., idle) channel before transmission. In some aspects, three kinds of type 2 channel access procedure are available: type 2A, type 2B, and type 2C.

In a type 2A channel access procedure, a wireless device may transmit after sensing the channel to be available (e.g., idle) for at least a sensing interval of 25 μs. In one aspect, the type 2A channel access procedure may be used when the gap between a DL/UL transmission burst and a following UL/DL transmission burst is greater than or equal to 25 μs. In a type 2B channel access procedure, a wireless device may transmit after sensing the channel to be available (e.g., idle) within a sensing interval of at least 16 μs. In one aspect, the type 2B channel access procedure may be used when the gap between a DL/UL transmission burst and a following UL/DL transmission burst is greater than or equal to 16 μs. In a type 2C channel access procedure, a wireless device may transmit without first sensing the channel, unlike the type 2A and type 2B channel access procedures. For example, the type 2C channel access procedure may be used when the gap between an UL/DL transmission burst and a following UL/DL transmission burst is smaller than or equal to 16 μs, and a duration of the transmission burst is at most 584 μs. In this case, the wireless device can omit sensing the channel before transmission.

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, UE 115i may perform a listen-before-talk (LBT) procedure. UE 115i may acquire a channel occupancy time (COT) based on the LBT procedure being successful. UE 115i may transmit COT sharing information to UE 115j during the COT for sharing the COT with UE 115j.

In some cases, an LBT procedure may include a wireless node adjusting its own backoff window based on the amount of energy detected on a channel or the acknowledge/negative-acknowledge (ACK/NACK) feedback for its own transmitted packets as a proxy for collisions. In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

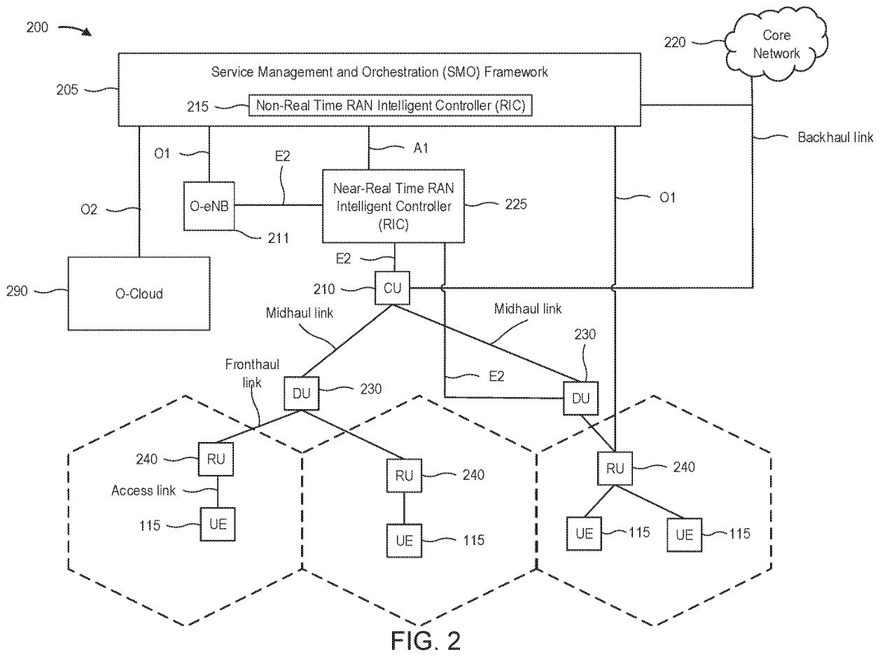

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 115 via one or more radio frequency (RF) access links. In some implementations, UE 115 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an Ol interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

For NR-U sideline (SL) operations, SL transmissions can be quite bursty. If each UE were to perform a CAT 4 LBT before initiating a COT, the channel access overhead may be large, and there may be high mutual blocking between such UEs. To address such issues, COT sharing has been suggested between UEs to make channel access more efficient. COT sharing between SL UEs may be implemented by the initiating UE providing COT sharing information to the additional SL UEs.

In some aspects, a first UE 115 may perform a listen-before-talk (LBT) procedure. The first UE 115 may acquire a channel occupancy time (COT) based on the LBT procedure being successful. The first UE 115 may transmit COT sharing information to a second UE 115 during the COT for sharing the COT with the second UE 115.

In some implementations, COT-structure information (COT-SI) may carry COT sharing information. In NR-U operations, downlink control information (DCI) format 2_0 has been enhanced to carry COT-SI. Such COT-SI may include time domain information, such as COT duration. If the COT-SI is not present in the DCI message, the slot format indicator (SFI) may be used as COT duration. COT-SI may also include frequency domain information identifying the frequency range of the COT. Such frequency domain information may be provided via a resource block (RB) set indicator which may include one bit for each RB set. Consideration may be given to the level of information to provide. For example, a UE initiating COT sharing may provide just the time and frequency domain boundaries of the COT. Alternatively, FDM and TDM sharing regions may be provided. Further still, a UE initiating COT sharing may provide even more details on the COT time/frequency parameters and a description of the sharable and/or non-sharable resources within the COT.

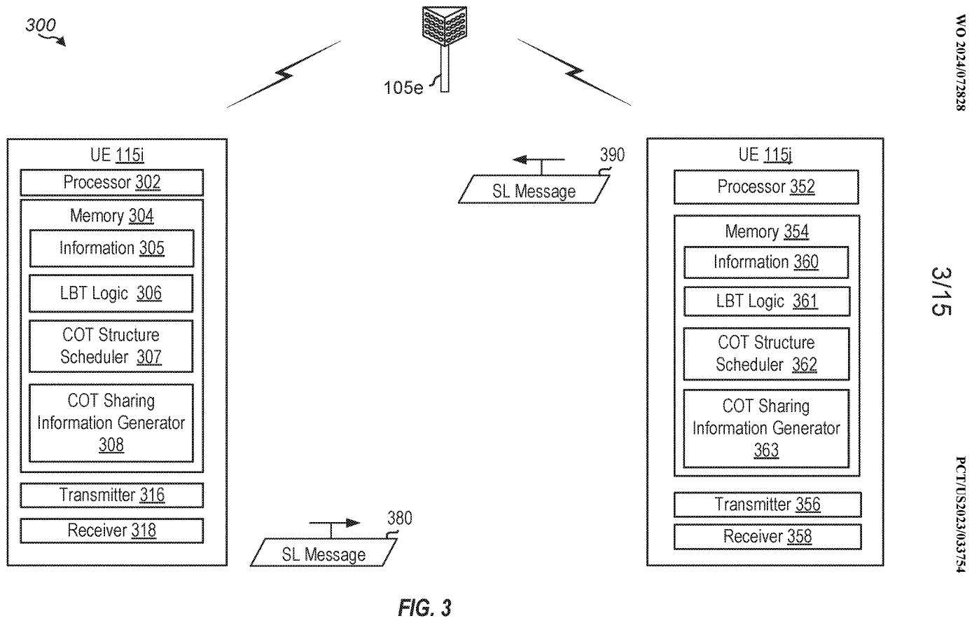

FIG. 3 is a block diagram of an example wireless communication system 300 that supports COT sharing information for NR-U SL operations according to one or more aspects. In some examples, wireless communication system 300 may implement aspects of wireless communication network 100. Wireless communication system 300 includes UEs 115i and 115j and base station 105e. Although two UEs and one base station are illustrated, in some other implementations, wireless communication system 300 may generally include multiple UEs, similar to UEs 115i and 115j, and may include more than one base station, similar to base station 105e.

UEs 115i and 115j may include a variety of components (such as structural, hardware components) used for carrying out one or more functions described herein. For example, these components may include one or more processors 302/352 (hereinafter referred to respectively as “processor 302” and “processor 352”), one or more memory devices 304/354 (hereinafter referred to respectively as “memory 304” and “memory 354”), one or more transmitters 316/356 (hereinafter referred to respectively as “transmitter 316” and “transmitter 356”), and one or more receivers 318/358 (hereinafter referred to respectively as “receiver 318” and “receiver 358”). Processor 302 and processor 352 may be configured to execute instructions stored in memory 304 and memory 354, respectively, to perform the operations described herein.

As illustrated, memory 304 and memory 354 include or are configured to store information 305/360, LBT logic 306/361, COT structure scheduler 307/362, and COT sharing information generator 308/363. Memory 304 and memory 354 would include or would be configured to store additional code or information for general communication operations. The identified memory items herein are used in support of the COT sharing information for NR-U SL operations according to one or more aspects described herein. For example, information 305/360 may include data or control information identified for either or both of uplink transmissions, via base station 105e, or sideline transmissions to other neighboring UEs (e.g., UE 115k). LBT logic 306/361 includes the code and instructions for implementing LBT capabilities at UEs 115i and 115j. Under control of processor 302 or processor 352, respectively, UE 115i or 115j executes LBT logic 306/361 to enable an LBT procedure (e.g., CCA, CAT 1-4 LBT, etc.). The functionality implemented and enabled through execution of LBT logic 306/361 may be referred to herein as the “execution environment” of LBT logic 306/361. With operations in an NR-U network, such as wireless communications system 300, UEs 115a and 115b may perform an LBT procedure within the execution environment of LBT logic 306/361 in order to secure a COT for uplink or SL transmissions.

The execution environment of COT structure scheduler 307/362, when executed under control of processor 302 or processor 352, respectively, enables UE 115i or 115j to manage a COT secured by a successful LBT procedure. UE 115a or 115b may, respectively, under control of the associated processor 302 or processor 352, execute COT sharing information generator 308/363 to generate the COT sharing information for communicating structure information and sharing indicator regarding the current COT to neighboring UEs for SL communications (e.g., UE 115j to UE 115i SL transmissions, or UE 115i to UE 115j SL transmissions).

Transmitter 316 and transmitter 356 are configured to transmit reference signals, control information and data to one or more other devices, such as base station 105e via uplink transmissions or another UE (e.g., UE 115j or UE 115i) via SL transmissions, and receiver 318 and receiver 358 are configured to receive references signals, synchronization signals, control information and data from one or more other devices. For example, transmitter 316 may transmit signaling, control information and data to, and receiver 318 may receive signaling, control information and data from, base station 105e or UE 115j. In some implementations, transmitter 316 and receiver 318 may be integrated in one or more transceivers.

According to one aspect of the present disclosure, UE 115i may successfully establish a COT on the shared communication spectrum of wireless communications network 300 after detecting a successful LBT procedure performed within the execution environment of LBT logic 306. UE 115i may then determine, within the execution environment of COT structure scheduler 307, a duration of the current COT as well as the time and frequency resource boundaries of the COT. Such time and frequency resources may be indicated via a set of resource blocks (RBs) for the COT identified by a bit map, where each bit identifies an RB of the set. With the structure information on the current COT determined, UE 115i may, within the execution environment of COT sharing information generator 308, generate a COT sharing information that includes the remaining COT duration and time and frequency resources of the current COT. UE 115i may then transmit the COT sharing information (e.g., SL message 380) using transmitter 316 for SL transmission.

In some implementations, COT sharing information may be transmitted in COT-SI. In one example implementation, UE 115i may instruct transmitter 316 to piggyback the COT sharing information with other transmission in a unicast, groupcast, or broadcast-type transmissions, such as part of sidelink control information 1 (SCI-1) or sidelink control information 2 (SCI-2). Current standards provide that all UEs may have the capability to decode the information in the two SCI formats (SCI-1 and SCI-2).

Alternatively, UE 115i may instruct transmitter 316 to separately transmit the COT sharing information in a dedicated transmission, e.g., within an SCI-2 or within a physical sidelink shared channel (PSSCH) communication, a physical sidelink control channel (PSCCH) communication, and/or other suitable communication. UE 115j may receive SL message 380 via receiver 358 including the COT sharing information and know that it may share transmission resources with the COT initiated by UE 115i.

It should be noted that, while the previous description of COT establishment and communication of COT sharing information to neighboring UEs was described with respect to UE 115i being the COT-initiating UE, the various aspects may also be implemented by other neighboring UEs, such as UE 115j. In such alternative example, UE 115j would establish the COT and communicate the COT sharing information, such as via SL message 390, to UE 115i in a similar manner.

It should further be noted that SL communication capability, such as the SL communication capabilities of UEs 115i and 115j may be configured as an autonomous capability, such that UEs 115i and 115j may autonomously elect to perform SL communications when supported by the environment where UEs 115i and 115j are located. Additional aspects may provide for SL communication capabilities to be controlled by the network, such as via enablement signals transmitted from base station 105e. In such additional aspects, base station 105e may determine whether the current environment would support or benefit from UE SL communications and, in response to such determination, signal SL communication enabling signals to either or both of UEs 115i and 115j.

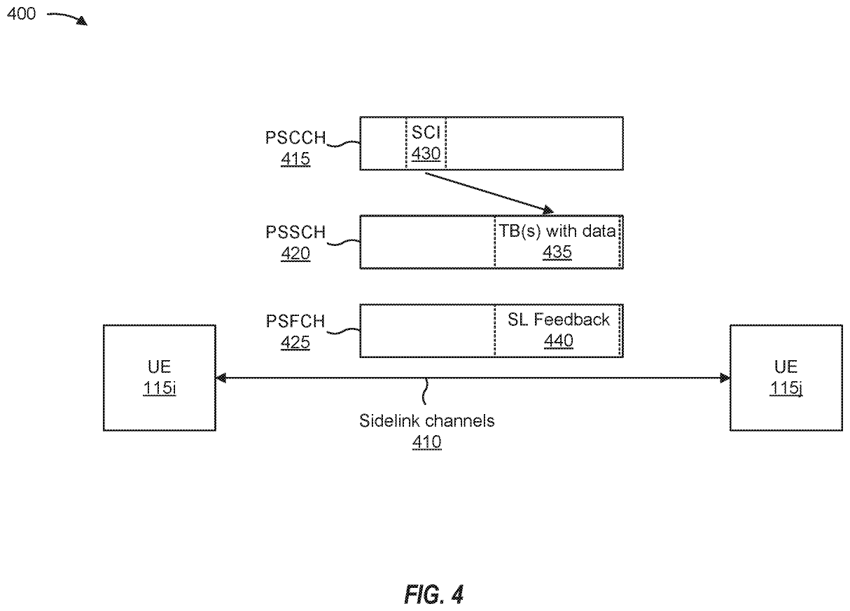

FIG. 4 is a diagram illustrating an example 400 of SL communications between UEs 115i and 115j, in accordance with various aspects of the present disclosure. As shown in FIG. 4, UE 115i may communicate with UE 115j (and one or more other UEs 115) via one or more SL channels 410. In some aspects, UEs 115i and 115j may communicate using one or more SL channels 410 for P2P communications, D2D communications, V2X communications (e.g., which may include V2V communications, V2I communications, V2P communications, V2N communications, and/or the like), mesh networking, and/or the like. In some aspects, UEs 115i and 115j may correspond to one or more other UEs described elsewhere herein, such as UE 115k. In some aspects, the one or more SL channels 410 may use a PC5 interface and/or may operate in a high frequency band (e.g., the 5.9 GHz band). For example, in a first mode, sometimes referred to as mode 1 and/or the like, a base station (e.g., base station 105e) may allocate resources for the one or more SL channels 410, may provide a dynamic grant or activate a configured SL grant for SL communications, may receive SL feedback reported by a transmitting UE, and/or the like. Additionally, or alternatively, in a second mode, sometimes referred to as mode 2 and/or the like, UEs 115i and 115j may autonomously select SL resources for the one or more SL channels 410, and SL communications may be scheduled using sidelink control information (SCI). Additionally, or alternatively, in some cases, the UEs 115i and 115j may synchronize timing of transmission time intervals (TTIs) (e.g., frames, subframes, slots, symbols, and/or the like) using global navigation satellite system (GNSS) timing.

As further shown in FIG. 4, one or more SL channels 410 may include a physical sidelink control channel (PSCCH) 415, a physical sidelink shared channel (PSSCH) 420, a physical sidelink feedback channel (PSFCH) 425, and/or the like. PSCCH 415 may be used to communicate control information, similar to a physical downlink control channel (PDCCH) and/or a physical uplink control channel (PUCCH) used for cellular communications with base station 105e via an access link or an access channel. PSSCH 420 may be used to communicate data, similar to a physical downlink shared channel (PDSCH) and/or a physical uplink shared channel (PUSCH) used for cellular communications with base station 105e via an access link or an access channel. For example, PSCCH 415 may carry SCI 430, which may indicate various control information used for sidelink communications, such as one or more resources (e.g., time resources, frequency resources, spatial resources, and/or the like) where a transport block (TB) 435 may be carried on PSSCH 420. TB 435 may include data. PSFCH 425 may be used to communicate SL feedback 440, such as hybrid automatic repeat request (HARQ) feedback (e.g., acknowledgement or negative acknowledgement (ACK/NACK) information), transmit power control (TPC), a scheduling request (SR), and/or the like.

In some aspects, one or more SL channels 410 may use resource pools. For example, a scheduling assignment (e.g., included in SCI 430) may be transmitted in subchannels using specific resource blocks (RBs) across time. In some aspects, data transmissions (e.g., on PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 115 (e.g., UE 115i or UE 115j) may operate using a transmission mode where resource selection and/or scheduling is performed by UE 115 (e.g., rather than base station 105e). In some aspects, UE 115 may perform resource selection and/or scheduling by sensing channel availability for transmissions. For example, UE 115 may measure a received signal strength indicator (RSSI) parameter (e.g., a SL-RSSI (S-RSSI) parameter) associated with various SL channels, may measure a reference signal received power (RSRP) parameter (e.g., a PSSCH-RSRP parameter) associated with various SL channels, may measure a reference signal received quality (RSRQ) parameter (e.g., a PSSCH-RSRQ parameter) associated with various SL channels, and/or the like, and may select a channel for transmission of a SL communication based at least in part on the measurement(s).

Additionally, or alternatively, UE 115 may perform resource selection and/or scheduling using SCI 430 received in PSCCH 415, which may indicate occupied resources, channel parameters, and/or the like. Additionally, or alternatively, UE 115 may perform resource selection and/or scheduling by determining a channel busy rate (CBR) associated with various SL channels, which may be used for rate control (e.g., by indicating a maximum number of resource blocks that UE 115 can use for a particular set of subframes).

In the transmission mode where resource selection and/or scheduling is performed by UE 115, UE 115 may generate SL grants in COT sharing information, and may transmit the grants in SCI 330. A SL grant may indicate, for example, one or more parameters (e.g., transmission parameters) to be used for an upcoming SL transmission, such as one or more resource blocks to be used for the upcoming SL transmission on PSSCH 420 (e.g., for TBs 435), one or more subframes to be used for the upcoming SL transmission, a modulation and coding scheme (MCS) to be used for the upcoming SL transmission, and/or the like. In some aspects, UE 115 may generate a SL grant that indicates one or more parameters for semi-persistent scheduling (SPS), such as a periodicity of a SL transmission. Additionally, or alternatively, UE 115 may generate a SL grant for event-driven scheduling, such as for an on-demand SL message.

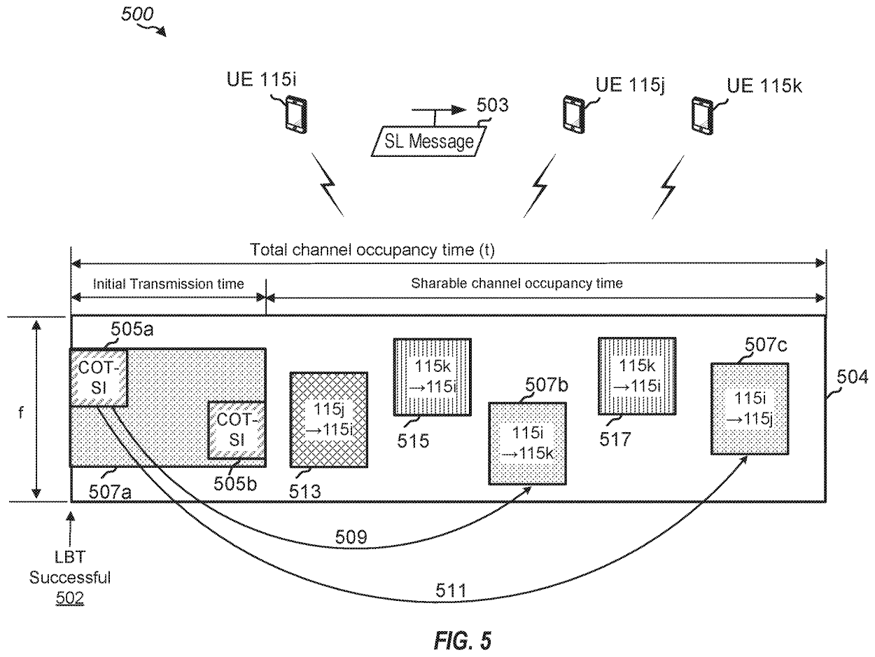

FIG. 5 is a diagram illustrating wireless communication systems 500 having UEs, such as UEs 115i, 115j, and 115k, for NR-U SL operations according to aspects of the present disclosure. In some examples, wireless communication system 500 may implement aspects of wireless communication network 100. After performing a successful LBT procedure or other clear channel assessment (CCA), UE 115i may acquire a COT within an unlicensed (e.g., shared) spectrum of wireless communication system 500 and send COT sharing information to other UEs to share the acquired COT. UE 115i may be denoted as a COT initiator (or initiating UE), and other UEs (e.g., UEs 115j and 115k) may be denoted as COT responders (or responding UEs).

In some instances, UE 115i may perform an LBT procedure 502 (or other CCA) to gain access to a COT in an unlicensed (e.g., shared) spectrum. For example, UE 115i may perform a category 1 LBT, a category 2 LBT, a category 3 LBT, and/or a category 4 LBT to gain access to COT 504 in an unlicensed frequency spectrum. In some aspects, UE 115i may perform the LBT in one or more time resources, spatial resources, and/or frequency resources. The frequency resources may include a frequency spectrum, a frequency band, a frequency sub-band, a frequency subchannel, resource elements, resource blocks, and/or a frequency interlace. The time resources may include slot(s), sub-slot(s), symbol(s), subframe(s), or any other suitable time resources. In some aspects, UE 115i may perform the LBT for one or more directional beams (e.g., a beam in the direction of a UE that UE 115i intends to transmit a communication to and/or receive a communication from).

UE 115i may acquire COT 504 based on LBT procedure 502 being successful. UE 115i may acquire COT 504 to transmit a SL communication to another UE (or UEs). Additionally or alternatively, UE 115i may share COT 504 with other UEs. Accordingly, the total channel occupancy time may be divided into an initial time period during which the initiating UE may perform transmissions, which may include COT sharing information that indicates when the initial transmission will end, a remaining duration of the channel occupancy time that is available for sharing, and/or the like. One or more responding UEs may monitor the COT sharing information transmitted by other UEs (e.g., the initiating UE) to recover COT sharing information that can be used to perform transmissions during a time period that corresponds to a shared channel occupancy time.

The COT sharing information may include a COT resource allocation that indicates resources a responding UE may use to share the COT. In some aspects, the initiating UE may transmit the COT sharing information to a responding UE and other UEs (e.g., a group of UEs, a set of UEs). The initiating UE may transmit the COT sharing information including resource allocations to the set of UEs to share the COT with the set of UEs.

In some aspects, the initiating UE may transmit the COT sharing information via sidelink control information (e.g., SCI-1, SCI-2), an RRC message, a PSCCH message, a PSSCH message, or other suitable communication. For example, the initiating UE may transmit the COT sharing information in a SL_COT_SharingInformation field via sidelink control information 2 (SCI-2).

In some aspects, the COT sharing information may include information (e.g., parameters, resources, settings, commands, etc.) to enable the initiating UE to share the COT with other UEs. Sharing the COT with other UEs may enable the other UEs to transmit and/or receive communications during the COT in an efficient and coordinated fashion. In some aspects, the COT sharing information may include identifiers associated with the set of UEs that share the COT. The identifiers may include layer one identifiers unique to each UE that shares the COT. In some aspects, the COT sharing information may indicate a type of channel access procedure associated with the COT. For example, the COT sharing information may indicate whether the COT is associated with a type 2A channel access procedure, a type 2B channel access procedure, or a type 2C channel access procedure.

In some aspects, the COT sharing information may include a time resource allocation associated with the COT sharing. For example, the time resource allocation may include a COT start time, a COT end time, and/or a COT duration. The time resource allocation may include time resources (e.g., slots, sub-slots, symbols, frames, etc.) allocated to the set of UEs that share the COT. For example, the time resource allocation may indicate index(s) indicating starting slot(s) and/or sub-slot(s) allocated to the set of UEs. The time resource allocation may indicate a number of time resources (e.g., a number of slots, sub-slots, and/or symbols) allocated to the set of UEs. For example, the time resource allocation may indicate slot 1 is allocated to the initiating UE, slot 2 is allocated to a responding UE, and slot 3 is allocated to another responding UE. The initiating UE may indicate the time resource allocation(s) to the responding UEs sharing the COT in a time domain resource allocation (TDRA) via SCI-1.

In some aspects, the COT sharing information may include a frequency resource allocation (e.g., frequency range(s)) associated with the COT sharing. For example, the frequency resource allocation may include a starting frequency (e.g., a starting frequency subchannel index, a starting frequency band, a starting frequency interlace). The frequency resource allocations may include an ending frequency (e.g., an ending subchannel, an ending frequency band). The frequency resource allocations may include a frequency interlace (e.g., a frequency interlace index, indexes of subchannels). The frequency resource allocation may indicate frequency resources allocated to the set of UEs that share the COT with the initiating UE. The initiating UE may indicate the frequency resource allocation(s) to the responding UEs sharing the COT in a frequency domain resource allocation (FDRA) via SCI-1.

In some aspects, the initiating UE may transmit a flag indicating the initiating UE is sharing the COT. In this regard, the initiating UE may transmit the flag via SCI (e.g., SCI-1, SCI-2) indicating the initiating UE is sharing the COT. The flag may include a single bit (e.g., 0 or 1) indicator, a multi-bit indicator, a code point, or other indicator to indicate the other UEs (e.g., the responding UEs receiving the flag) may share the COT.

In some aspects, the initiating UE may transmit the flag in SCI-2 via a PSSCH. The SCI-2 may include destination identifier(s) associated with a responding UE and other UEs indicating the initiating UE shares the COT with the responding UE and the other UEs. The UEs in proximity to the initiating UE that receive and decode the SCI-2 may share the COT with the initiating UE if the SCI-2 includes an identifier that matches the identifier associated with the receiving UE.

In some aspects, the COT sharing information may indicate a groupcast identifier associated with a set of UEs for sharing the COT with the initiating UE. In this regard, the initiating UE may transmit the COT sharing information via SCI-2. The SCI-2 may include a groupcast identifier that indicates the set of UEs that may share the COT.

Still referring to FIG. 5, according to the illustrated aspect, UE 115i may transmit COT sharing information via COT-SI. In generating a COT-SI 505a, UE 115i may determine the time and frequency resources (t×f) defining COT 504 and also determine a set of time and frequency resources defining a reserved set of resources, such as a reserved resource region 507a. UE 115i may then transmit COT-SI 505a via SL message 503 to neighboring UEs, such as UEs 115j and 115k. COT-SI 505a may include the remaining duration of COT 504, the time and frequency resources (t×f) defining COT 504, and the set of time and frequency resources defining reserved resource region 507a.

By including the set of time and frequency resources defining reserved resource region 507a, UE 115i provides additional information to UEs 115j and 115k that defines a sharable COT region within COT 504. The sharable COT region may further include sharable TDM region and/or sharable FDM region. Other UEs, such as UEs 115j and 115k, can perform TDM sharing in the sharable TDM region, and FDM sharing in the sharable FDM region. UEs 115j and 115k will also know that reserved resource region 507a is not sharable and, thus, UEs 115j and 115k will not attempt access to the shared communication spectrum within COT 504 that falls within reserved resource region 507a. Such an enhanced design may take advantage of the bursty nature of these transmissions, such as with enhanced mobile broadband (eMBB) traffic.

Current mechanisms defined for SCI-1 messaging allows for an initiating UE to allocate extra further slots within certain slot range of a current COT that are reserved for the initiating UE communication and not sharable with neighboring UEs. After successfully acquiring COT 504 with a successful LBT procedure 502, UE 115i may generate COT-SI 505a to include not only the remaining duration of COT 504, and the time and frequency resources of COT 504, but also identification of extra reserved resource regions 507b and 507c as indicated by arrows 509 and 511. The reserved resource regions 507b and 507c are reserved for UE 115i SL communications and are not shareable by other UEs, including UEs 115j and 115k. UE 115i would send such COT-SI 505a to UEs 115j and 115k via SL message 503.

Additionally or alternatively, UE 115i may generate a second COT-SI 505b, which indicates the remaining duration of COT 504 becomes sharable. For example, COT-SI 505a may determine the time and frequency resources (t×f) defining COT 504, but does not further indicate when COT 504 would become sharable. On the other hand, COT-SI 505b may provide additional information to UEs 115j and 115k that defines a sharable COT region (or shared COT) within COT 504. For example, COT-SI 505b may locate at an end of the reserved resource region 507a and function as a flag indicating a starting point of the shared COT. UEs 115j and 115k in proximity to UE 115i that receive and decode COT-SI 505b may become aware that remaining portion of COT 504 is now sharable and may acquire slots in the shared COT (such as in sharable resource regions 513, 515, and 517) to send SL communications to UE 1. COT-SI 505b may further provide other structure information for COT 504. For example, identification of reserved resource regions 507b and 507c may be provided by COT-SI 505b, additionally or alternatively to COT-SI 505a.

In some aspects, UEs 115j and 115k contend for access to sharable channel occupancy time. According to the illustrated example, UE 115j may perform an LBT procedure and acquire a sharable region 513 to transmit an SL communication to UE 115i upon the LBT procedure being successful, UE 115k may perform an LBT procedure and acquire a sharable region 515 to transmit an SL communication to UE 115i upon the LBT procedure being successful, UE 115k may perform another LBT procedure and acquire another sharable region 517 to transmit an SL communication to UE 115i upon the LBT procedure being successful. UE 115i may transmit an SL communication to UE 115k in a reserved region 507b that is reserved to UE 115i and transmit an SL communication to UE 115j in a reserved region 507c that is reserved to UE 115i.

In the context of responding UEs detecting COT sharing information which identifies a particular resource as sharable, the network may provide that the assumption of the resource being sharable will always be valid. Enforcing consistency may provide the more restrictive aspect, in which the identified sharable or non-sharable status of resources for a particular COT will not change. However, if the initiating UE changes its mind or encounters a change in communications (e.g., if high priority traffic with a packet delay budget (PDB) coming up) and wants to use a previously-indicated sharable resource, the initiating UE may want to transmit in the previously shared COT and/or reclaim the previously shared COT for its own use.

In some aspects, the initiating UE may have some information about when to resume transmission in a previously-indicated sharable resource based on the COT sharing information. For example, if the COT sharing information grants access to a single responding UE and indicates a type 2C channel access procedure, when the initiating UE receives a response from the responding UE, the initiating UE would know a duration of the transmission is at most 584 μs. The initiating UE may thus predict an end of the response. In most of cases though, there may be more flexibility for types of the channel access procedure, and one or more responding UEs may try to send responses in the shared COT, which makes the initiating UE hard to predict an end of the responses.

Still referring to FIG. 5, in the illustrated aspect, in a shared COT, there may be multiple gaps among responses from UEs (e.g., gaps among resource regions 507a, 513, 515, 507b, 517, and 507c). Accordingly, a UE (either an initiating UE or a responding UE) may resume transmissions one or more times during a shared COT by performing a channel access procedure, such as a type 2 channel access procedure, based on duration of a gap with a reference transmission. For example, an initiating UE (or a responding UE) may attempt a transmission at a transmission starting point (TSP) where a type of channel access procedure is based on duration of a gap between the attempted TSP and a reference transmission. In some aspects, the reference transmission is an end of the latest transmission from the initiating UE before the shared COT (e.g., an end of the reserved resource region 507a). In some aspects, the reference transmission is an end of the initiating UE's latest transmission (e.g., an end of the resource region 507a, 507b, or 507c which occurs the latest). In some aspects, the reference transmission is an end of a latest transmission responding to the initiating UE. For example, if the initiating UE is included in the destinations of the transmission (e.g., the initiating UE is listed in destination identification in SCI-2), the transmission is considered as a transmission responding to the initiating UE. As another example, if the responding UE is an eligible responder of the COT (e.g., the responding UE is listed in a group for COT sharing indicated in the COT sharing information), the transmission from the responding UE is considered as a transmission responding to the initiating UE. In the illustrated aspect, responding UE 115j transmits to initiating UE 115i at resource region 513, responding UE 115k transmits to initiating UE 115i at resource region 515, and responding UE 115k transmits to initiating UE 115i at resource region 517, and each of these transmissions is qualified as a transmission responding to the initiating UE. Thus, the reference transmission may be an end of one of the resource region 513, 515, or 517 which occurs the latest.

In some implementations, the initiating UE would contend for access to the sharable resource with responding UEs. For example, in the illustrated aspect in FIG. 5, UE 115i transmits COT-SI 505b identifying the remaining duration of COT 504 as sharable resource. UE 115i subsequently encounters some change in communications, such as high priority traffic with a packet delay budget (PDB) coming up, which it determines to attempt transmissions within the previously-indicated sharable region.

However, because UE 115i does not originally schedule sharable region as a reserved region, such as reserved resource regions 507a, 507b, and 507c, before UE 115i may attempt SL communications within the shared COT, it would perform an LBT procedure in order to contend for access to the shared communication spectrum against the other neighboring UEs, such as UEs 115j and 115k. In other words, there will be no extra protection for the initiating UE, UE 115i, to use a sharable resource in its own COT, COT 504, even though UE 115i is still allowed to share use of the sharable resource. In this case, UE 115i will act as a responding device to itself.

In some implementations, the initiating UE may be granted priority in acquiring a TSP for retransmission within a sharable region. The TSP may correspond to a start of a portion of the COT that can be utilized by the initiating UE for retransmission in the resource shared with other UEs.

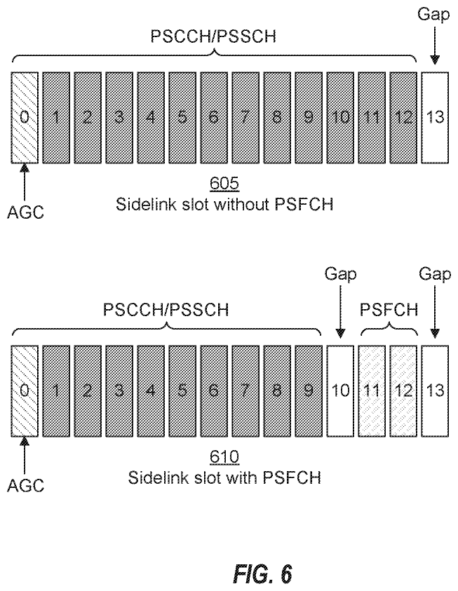

For example, as shown in FIG. 6, an SL slot structure 605 without a physical sidelink feedback channel (PSFCH) may include fourteen (14) symbols total, with thirteen (13) symbols indexed from zero (0) to twelve (12) available for physical sidelink control channel (PSCCH) and/or physical sidelink shared channel (PSSCH) transmissions and a final symbol (index thirteen (13)) in the slot left as a gap during which no transmissions are performed. Furthermore, as shown in FIG. 6, the first symbol is used for AGC training, whereby the second symbol (symbol 1) is a repetition of the first symbol (symbol 0) to increase reliability for the PSCCH and/or PSSCH transmission (e.g., because the receiving UE may be unable to properly receive and/or decode the first symbol prior to performing AGC training). Alternatively, an SL slot structure 610 with a PSFCH may include fourteen (14) symbols total, with ten (10) symbols indexed from zero (0) to nine (9) available for PSCCH and/or PSSCH transmissions, two symbols indexed eleven (11) and twelve (12) used for repetitions of a PSFCH symbol, and two symbols indexed ten (10) and thirteen (13) left as gaps during which no transmissions are performed. Regardless of whether the SL slot structure includes PSFCH symbols, the last symbol in a slot is a gap symbol and the first symbol in a slot is an automatic gain control (AGC) symbol, which is a repetition of the second symbol.

Accordingly, in some aspects, a UE (an initiating UE or a responding UE) may determine an attempted TSP, which may represent a start of a possible time when the UE can start a transmission in the COT shared by the initiating UE, within a joint period that includes the last symbol (symbol 13) in a current slot (e.g., a slot prior to the transmission) and the first symbol (symbol 0) in a next slot (e.g., a slot in which the UE is to perform the transmission).

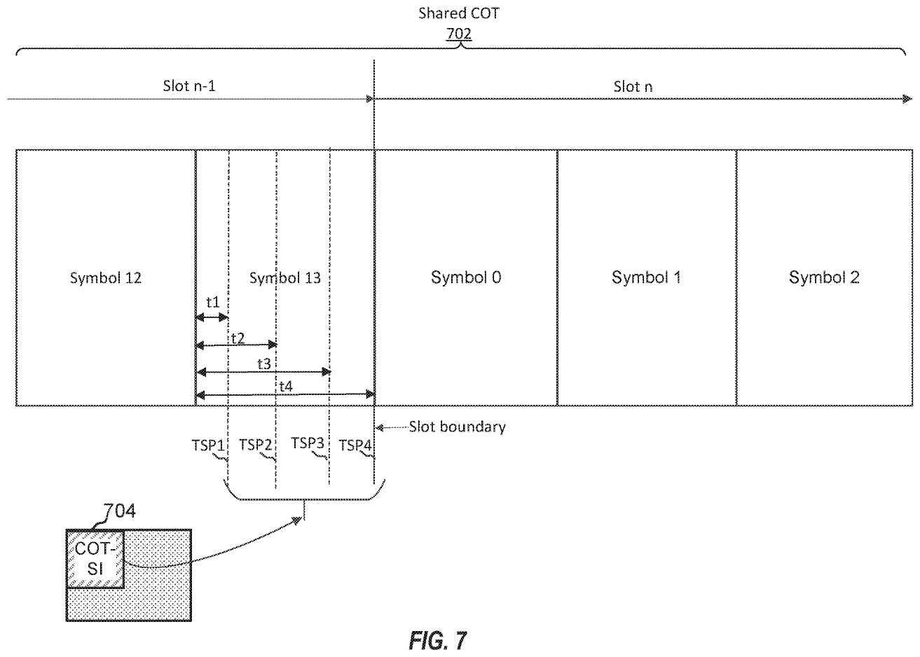

For example, as shown in FIG. 7, the COT may be configured with a group of TSPs (TSP1, TSP2, TSP3, and TSP4, as shown). In the illustrated aspect, the group of TSPs may be located in the gap symbol (e.g., symbol 13 of Slot n-1). Furthermore, in some aspects, the group of TSPs may extend into an AGC symbol (e.g., symbol 0 of Slot n), when the AGC period may correspond to a portion of symbol 0 (e.g., a second half of symbol 0). Still further, one of the TSPs (e.g., TSP4) may align with a slot boundary between the gap symbol and the AGC symbol. In some aspects, a UE may acquire a TSP located in a gap symbol (e.g., symbol 13) via cyclic prefix extension. In some aspects, a UE may acquired a transmission starting point located in an AGC symbol (e.g., symbol 0) via AGC symbol puncturing.

In some aspects, COT sharing information (e.g., COT-SI 704) may indicate the group of TSPs. For example, the COT sharing information may indicate the group of TSPs in the resource reservation and a UE may identify one of the TSPs as the attempted TSP.

A UE (an initiating UE or a responding UE) may perform a channel access procedure based at least in part on determining the transmission starting point. In some aspects, a UE may perform a channel access procedure based at least in part on a sensing structure associated with the TSP. The sensing structure associated with a TSP may be determined based at least in part on an amount of time between an end of a reference transmission and the transmission starting point.

In some aspects, a TSP may be associated with type 2C channel access procedure when the amount of time between the TSP and an end of a reference transmission is less than a first amount of time (e.g., less than 16 μs) and a duration of a transmission is less than a second amount of time (e.g., 584 μs). For example, as shown in FIG. 7, an amount of time t1 between an end of a reference transmission (e.g., a start of symbol 13) and a first TSP (TSP1) may be 9 μs. The UE may determine that 9 μs is less than the first amount of time. The UE may determine that the first TSP is associated with type 2C channel access procedure based at least in part on 9 μs being less than the first amount of time and when a duration of a transmission of the UE is within the second amount of time.

In some aspects, a TSP may be associated with type 2B channel access when the amount of time between the TSP and the end of the reference transmission point is equal to the first amount of time. For example, as shown in FIG. 7, an amount of time t2 between an end of the reference transmission and a second TSP (TSP2) may be 16 μs.

The UE may determine that the second TSP is associated with type 2B channel access procedure based at least in part on the amount of time between the second TSP and the end of the reference transmission being equal to the first amount of time.

In some aspects, a TSP may be associated with type 2A channel access when the amount of time between the TSP and the end of the reference transmission point is equal to a third amount of time (e.g., 25 μs). For example, as shown in FIG. 7, an amount of time t3 between an end of the reference transmission and a third TSP (TSP3) may be 25 μs. The UE may determine that the third TSP is associated with type 2A channel access procedure based at least in part on the amount of time between the third TSP and the end of the reference transmission being equal to the third amount of time. Further, the UE may determine that the subsequent TSP(s) (e.g., TSP4) are associated with type 2A channel access procedure based at least in part on the amount of time between the subsequent TSP(s) and the end of the reference transmission being larger than the third amount of time.

In some implementations, an initiating UE may not have any advantage in retransmission compared to other UEs in responding. The initiating UE may perform channel access procedure as a responding device to itself based on available transmission starting points.

In some implementations, an initiating UE may select a TSP from the group of TSPs based at least in part on a quantity of priorities indicated in the COT sharing information. For example, the COT sharing information may include a set of one or more bits, and a value of the one or more bits may correspond to a quantity of priorities associated with the group of TSPs. The initiating UE may determine a priority associated with each transmission starting point based at least in part on the quantity of priorities associated with the group of TSPs. For example, the set of one or more bits may be set to a first value (e.g., 1) to indicate that each of the group of TSPs is associated with a same priority (e.g., a highest priority). As another example, the one or more bits may be set to a second value (e.g., 2) to indicate that a first half of the TSPs (e.g., TSP1 and TSP2) are associated with a first priority (e.g., a highest priority) and that a second half of the TSPs (e.g., TSP3 and TSP4) are associated with a second priority (e.g., a next highest priority).

Furthermore, the COT sharing information indicating the group of TSPs may include a lookup table mapping a TSP index to TSP(s), a channel access priority class (CAPC), an LBT category type, and/or a CPE. For example, the lookup table may include one or more TSP entries that corresponds to a CAPC. In some aspects, each of the TSP(s) may correspond to a different CAPC. In some aspects, multiple TSPs may correspond to the same CAPC. In some aspects, the same TSP may correspond to multiple CAPCs.

The CAPC may be associated with an SL transmission. The transmission may be a transport block transmitted via a PSSCH. The CAPC associated with the SL communication may indicate the priority (e.g., latency budget) of the SL communication. In some aspects, a higher CAPC value (e.g., 4) may indicate a lower priority level while a lower CAPC value (e.g., 1) may indicate a higher priority level.

The COT sharing information may further indicate a cyclic prefix extension (CPE) length. A UE may transmit a CPE prior to transmitting an SL transmission to facilitate alignment of orthogonal frequency division multiplexing (OFDM) symbols and retain the shared COT by blocking other UEs contending for the shared COT.

The initiating UE may start transmitting the communication at a TSP based on a CAPC associated with the communication. The initiating UE may perform the LBT in slot symbol 13 (e.g., the gap symbol) just prior to the TSP that corresponds to the CAPC of the communication the initiating UE intends to transmit. If the LBT is successful, the initiating UE may transmit during the CPE between the TSP and the slot boundary (e.g., the boundary between the end of symbol 13 and symbol 0 of the next slot). By transmitting during the CPE starting at the TSP, the initiating UE may block other UEs contending for the shared COT. An SL communication having a high priority (e.g., lower CAPC value) may be assigned an earlier TSP than an SL communication having a lower priority (e.g., higher CAPC value). In this way, a UE having a high priority communication to transmit may be assigned an earlier TSP thereby blocking other COT sharing UEs having lower priority communications from gaining the shared COT. When more than one UE has a high priority communication to transmit (e.g., multiple UEs having the same CAPC value), the UEs may compete for an earlier TSP based on a random selection process. The random TSP selection process may provide a random chance for the contending UEs to be assigned the earlier TSP. In this regard, each of the contending UEs may select a TSP based on a hashing function of the multiple TSPs. For example, each of the contending UEs may select a TSP based on a hashing function of the multiple TSPs and a unique identifier associated with the contending UE.

In some implementations, the prioritization on TSPs may be based on roles of being an initiating UE or a responding UE. For example, one of the TSPs may be reserved to the initiating UE, and other UEs are forbidden to use the reserved TSP. In furtherance of the example, the earliest TSP (e.g., TSP1) in the group of TSPs may be solely reserved for the initiating UE and exclude other UEs from accessing it. Other TSPs other than the one reserved to the initiating UE may be available for responding UEs to contend. The COT sharing information may indicate which TSP is reserved.

On the other hand, a responding UE may treat reservation differently based on whether the reservation is from the initiating UE or from other UEs. In some aspects, a reservation is associated with a source ID (e.g., recorded and readable in SCI-2), and if a source ID of a reservation matches the one from the COT sharing information, a responding UE becomes aware that the reservation is from the initiating UE of the shared COT. In some aspects, the responding UE may completely refrain from attempting channel access in slots where the initiating UE has reserved resources. For example, if a slot or one of the TSPs before the slot is reserved for the initiating UE, the responding UE may refrain from attempting channel access from not just the reserved TSP but all the TSPs.

Alternatively, the responding UE may access TSPs only after detecting that the initiating UE is not using the reserved resource. For example, the responding UE may attempt the channel access at a later TSP to detect whether or not the initiating UE has been accessing the reserved TSP. When the LBT discloses there is no accessing to the reserved TSP by the initiating UE, the responding UE may start transmission at the later TSP. A stricter condition may be applied that the responding UE may attempt the channel access at a later TSP when the responding UE is not a target recipient of the initiating UE's transmission by reserving the reserved TSP. In other words, if the responding UE is a target recipient of the initiating UE's transmission by reserving the reserved TSP, the responding UE may refrain from attempting transmission at a later TSP even if no activity is detected on the reserved TSP. Whether the responding UE is a target recipient may be readable in the destination ID field of the reservation recorded in SCI-2.

Alternatively, to better utilize the shared spectrum, the responding UE may transmit an SL communication in an FDM with the initiating UE. In other words, the responding UE may transmit in the same slot with the initiating UE but different subchannels. Since FDM should be obtained by aligning the TSP with the initiating UE (that is, the TSP reserved for the initiating UE is also chosen by the responding TSP), so that the type 2 channel access procedure would not get blocked across the UEs, the responding UE may try to transmit in an FDM when its transmission is not a unicast to the initiating UE, but rather a groupcast or a broadcast. A stricter condition may be applied that the responding UE may transmit an SL communication that is not a unicast to the initiating UE and the responding UE is not a target recipient of the initiating UE's transmission by reserving the TSP. Whether the responding UE is a target recipient may be readable in the destination ID field of the reservation recorded in SCI-2. In other words, the initiating UE's transmission by reserving the TSP is either a unicast to a UE other than the responding UE or a groupcast to a group of UEs not including the responding UE.

While the example aspects describe with respect to FIGS. 5-7 provide for enforcing consistency in which the sharable status of resources for a particular COT will not change and the initiating UE would contend for access to sharable resource with other UEs (without advantage or with advantage (e.g., through priority or reservation)), the question arises as to whether the network should allow the sharable resource to change to be non-sharable.

In some implementations, an initiating UE may use a later transmission to other UEs to indicate that they can no longer access the shared COT and the remaining portion of the COT is reclaimed by the initiating UE.

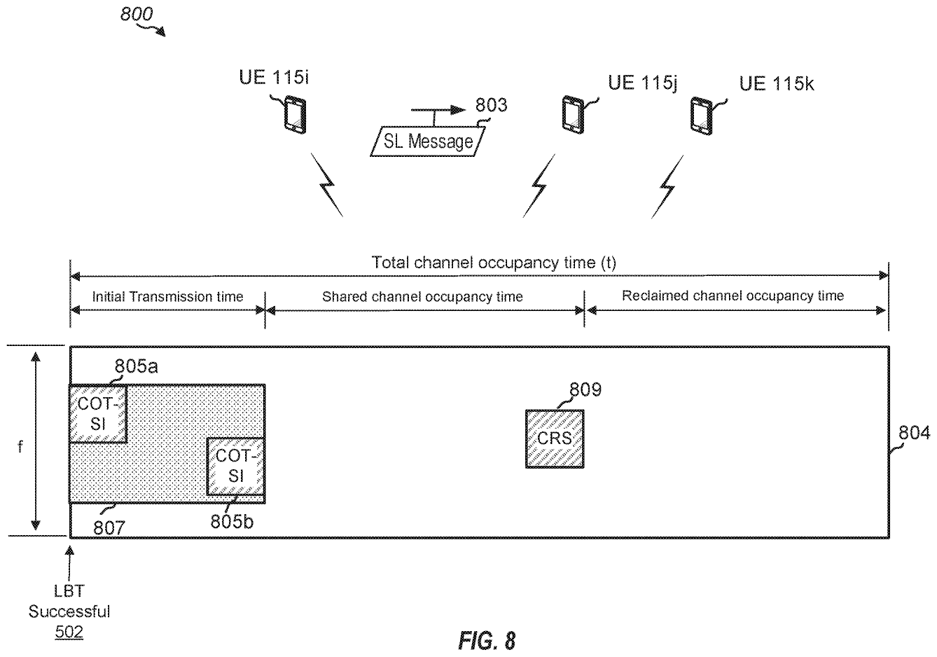

FIG. 8 is a diagram illustrating wireless communication systems 800 having UEs, such as UEs 115i, 115j, and 115k, for NR-U SL operations according to aspects of the present disclosure. In some examples, wireless communication system 800 may implement aspects of wireless communication network 100. After performing a successful LBT procedure or other clear channel assessment (CCA), UE 115i may acquire COT 804 within an unlicensed (e.g., shared) spectrum of wireless communications system 800 and send COT sharing information to other UEs to share the acquired COT.

According to the illustrated aspect, UE 115i may transmit COT sharing information via COT-SI. In generating a COT-SI 805a, UE 115i may determine the time and frequency resources (t x f) defining COT 804 and also determine a set of time and frequency resources defining a reserved set of resources, such as a reserved resource region 807. UE 115i may then transmit COT-SI 805a via SL message 803 to neighboring UEs, such as UEs 115j and 115k. COT-SI 805a may include the remaining duration of COT 804, the time and frequency resources (t×f) defining COT 804, and the set of time and frequency resources defining reserved resource region 807.

By including the set of time and frequency resources defining reserved resource region 807, UE 115i provides additional information to UEs 115j and 115k that defines a sharable COT region within COT 804. The sharable COT region may further include sharable TDM region and/or sharable FDM region. Other UEs, such as UEs 115j and 115k can perform TDM sharing in the sharable TDM region, and FDM sharing in the sharable FDM region. UEs 115j and 115k will also know that reserved resource region 807 is not sharable and, thus, UEs 115j and 115k will not attempt access to the shared spectrum within COT 804 that falls within reserved resource region 807.

Additionally or alternatively, UE 115i may generate a second COT-SI 805b, which indicates the remaining duration of COT 804 becomes sharable. For example, COT-SI 805a may determine the time and frequency resources (t×f) defining COT 804, but does not further indicate when COT 804 would become sharable. On the other hand, COT-SI 805b may provide additional information to UEs 115j and 115k that defines a sharable COT region within COT 804. For example, COT-SI 805b may locate at an end of the reserved resource region 807 and function as a flag indicating a starting point of the shared COT. UEs 115j and 115k in proximity to UE 115i that receive and decode COT-SI 805b may become aware that remaining portion of COT 804 is now sharable and may acquire slots in the shared COT to send SL communications.

The example aspect illustrated in FIG. 8 can be a more general aspect of the design allowing the initiating UE to change its mind for the shared COT. The illustrated aspect in FIG. 8 shows how UE 115i may change previously sharable region of COT 804 to non-sharable region. According to the illustrated aspect, UE 115i may transmit a COT reclaiming signal 809 to other UEs, such as UEs 115j and 115k. COT reclaiming signal 809 reverts remaining portion of the COT 804 from a shared COT to a reserved COT.

After receiving the COT reclaiming signal 809, UEs 115j and 115k would refrain from accessing the remaining portion of the COT 804. After reverting the remaining portion of COT 804 to a reserved COT, UE 115i may transmit SL communications in the remaining portion of COT 804 without risks of collision with other contending UEs.

In some aspects, COT reclaiming signal 809 may be a flag signal that indicates the end of the current slot containing the COT reclaiming signal as the end of the shared COT. Alternatively, COT reclaiming signal 809 may indicate the end of the sharing of the COT is offset by one or more slots from a current slot containing the COT reclaiming signal. COT reclaiming signal 809 may define the amount of slots as offset.

In some aspects, COT reclaiming signal 809 may be transmitted vias a COT-SI, SCI-1 or SCI-2, information contained in PSFCH (requires other formats than PFO). In some aspects, to function as a flag signal that indicates the end of the current slot as the end of the shared COT, COT reclaiming signal 809 may be transmitted as a PSFCH mapped to one of the initiating UE's transmissions when HARQ Feedback is disabled to implicitly indicate that the previously-shared COT is reclaimed.

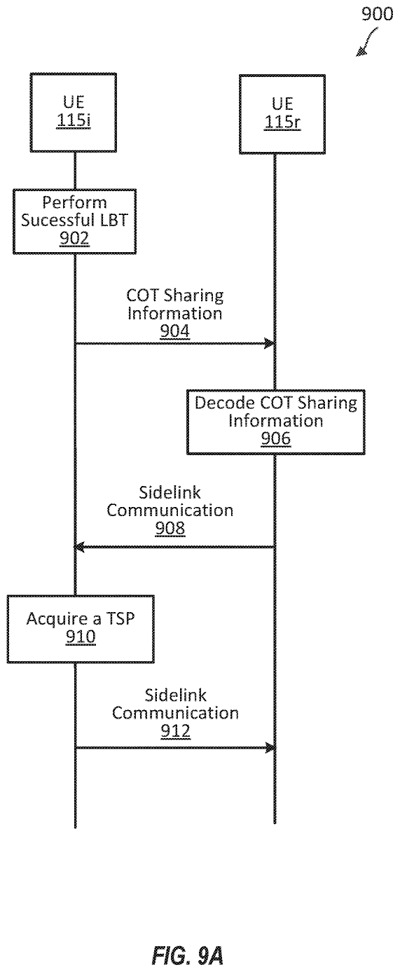

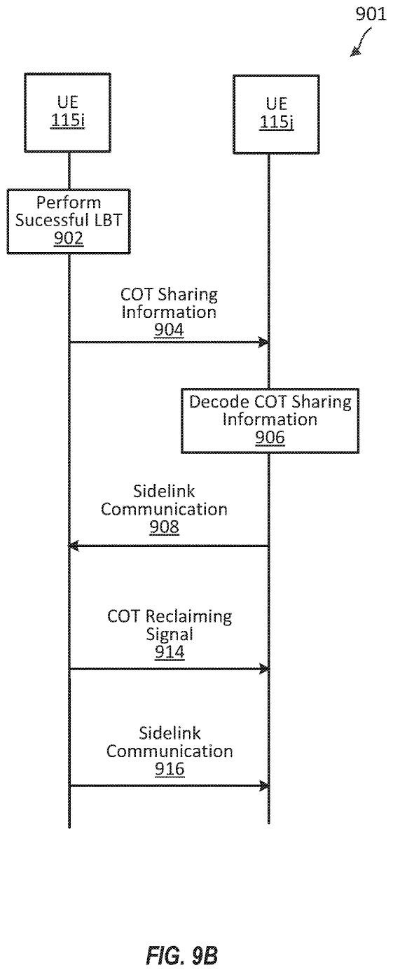

FIG. 9A is a signaling diagram of a wireless communication method 900 according to some aspects of the present disclosure. Actions of the communication method 900 can be executed by a computing device (e.g., a processor, processing circuit, and/or other suitable component) of a communication device or other suitable means for performing the actions. For example, a wireless communication device, such as UE 115i and UE 115j, may utilize one or more components, such as processor 1002, memory 1004, COT sharing module 1008, transceiver 1010, modem 1012, and one or more antennas 1016, to execute aspects of method 900.

At action 902, UE 115i may perform a successful LBT. The UE 115i may perform a category 1 LBT, a category 2 LBT, a category 3 LBT, and/or a category 4 LBT to gain access to the COT in an unlicensed frequency spectrum.

At action 904, UE 115i may transmit COT sharing information via COT-SI, sidelink control information (e.g., SCI-1, SCI-2), an RRC message, a PSCCH message, a PSSCH message, or other suitable communication to UEs 115j. For example, UE 115i may transmit the COT sharing information in a SL_COT_SharingInformation field via sidelink control information 2 (SCI-2). In some aspects, the COT sharing information may include information (e.g., parameters, resources, settings, commands, etc.) to enable the UE 115i to share the COT with UE 115j. Sharing the COT with one or more other UEs may enable the other UEs to transmit and/or receive communications during the COT in an efficient and coordinated fashion. In some aspects, the COT sharing information may include identifiers associated with the set of UEs that share the COT. The UE identifiers may include layer one identifiers unique to each UE that shares the COT.

At action 906, UE 115j may decode the COT sharing information received from UE 115i. The COT sharing information may include a COT resource allocation that indicates resources UE 115j may use to share the COT. The COT sharing information may also provide a group of transmission starting points (TSPs) with priority information and/or reservation information.

At action 908, UE 115j may transmit an SL communication to UE 115i in the resources allocated in the COT sharing information. UE 115j may transmit the SL communication based on a TSP associated with a priority (e.g., CAPC) that is associated with the UE 115j.

At action 910, UE 115i may acquire a TSP for transmitting an SL communication in the shared COT. UE 115i may acquire the TSP by contending without any advantage to UE 115j. Alternatively, UE 115i may acquire the TSP based on a priority (e.g., CAPC) associated with the UE 115i. For example, UE 115i may have a lower CAPC value indicating higher priority than UE 115j. Therefore UE 115i may transmit before the UE 115j. Alternatively, UE 115i may acquire the TSP based on the TSP being exclusively reserved for UE 115i.

At action 912, UE 115i may transmit an SL communication to UE 115j in the resources starting with the acquired (or reserved) TSP. For example, UE 115i may transmit during the cyclic prefix extension (CPE) between the TSP and the slot boundary (e.g., the boundary between the end of symbol 13 and symbol 0 of the next slot). By transmitting during the CPE starting at the TSP, UE 115i may block other UEs contending for the shared COT.

FIG. 9B is a signaling diagram of a wireless communication method 901 according to some aspects of the present disclosure. Actions of the communication method 901 can be executed by a computing device (e.g., a processor, processing circuit, and/or other suitable component) of a communication device or other suitable means for performing the actions. For example, a wireless communication device, such as UE 115i and UE 115j, may utilize one or more components, such as processor 1002, memory 1004, COT sharing module 1008, transceiver 1010, modem 1012, and one or more antennas 1016, to execute aspects of method 901.

At action 902, UE 115i may perform a successful LBT. The UE 115i may perform a category 1 LBT, a category 2 LBT, a category 3 LBT, and/or a category 4 LBT to gain access to the COT in an unlicensed frequency spectrum.

At action 904, UE 115i may transmit COT sharing information via COT-SI, sidelink control information (e.g., SCI-1, SCI-2), an RRC message, a PSCCH message, a PSSCH message, or other suitable communication to UEs 115j. For example, UE 115i may transmit the COT sharing information in a SL_COT_SharingInformation field via sidelink control information 2 (SCI-2). In some aspects, the COT sharing information may include information (e.g., parameters, resources, settings, commands, etc.) to enable the UE 115i to share the COT with UE 115j. Sharing the COT with one or more other UEs may enable the other UEs to transmit and/or receive communications during the COT in an efficient and coordinated fashion. In some aspects, the COT sharing information may include identifiers associated with the set of UEs that share the COT. The UE identifiers may include layer one identifiers unique to each UE that shares the COT.

At action 906, UE 115j may decode the COT sharing information received from UE 115i. The COT sharing information may include a COT resource allocation that indicates resources UE 115j may use to share the COT. The COT sharing information may also provide a group of transmission starting points (TSP) with priority information and/or reservation information.

At action 908, UE 115j may transmit an SL communication to UE 115i in the resources allocated in the COT sharing information. UE 115j may transmit the SL communication based on a TSP associated with a priority (e.g., CAPC) that is associated with the UE 115j.

At action 914, UE 115i may transmit a COT reclaiming signal to reclaim the remaining portion of the shared COT and convert the shared COT to a reserved COT. The COT reclaiming signal refrains UE 115j from accessing remaining portion of the shared COT.

At action 916, UE 115i may transmit an SL communication to UE 115j in the resources in the reclaimed COT. Since the reclaimed COT is reserved to UE 115i, UE 115i does not need to compete with other UEs through contention to send SL communications.

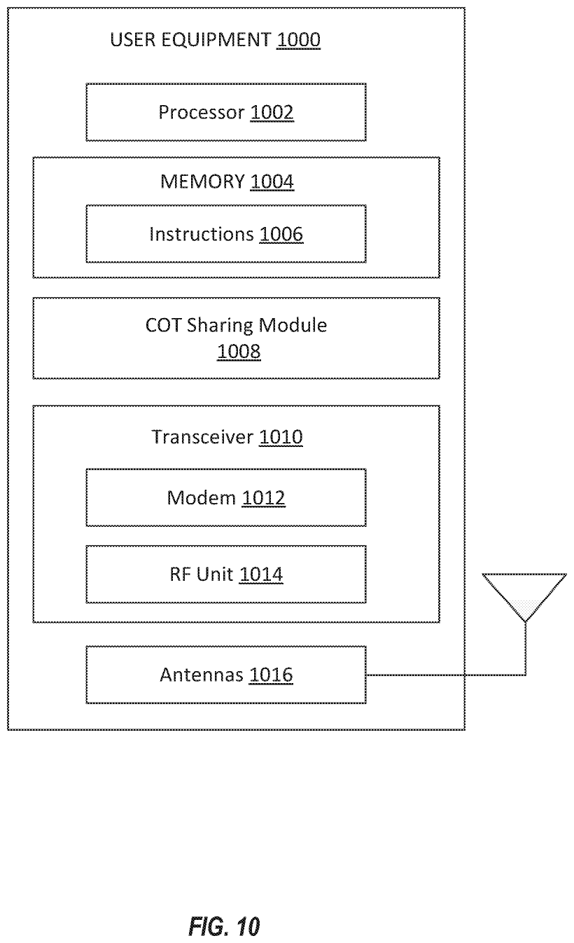

FIG. 10 is a block diagram of an exemplary UE 1000 according to some aspects of the present disclosure. As shown, the UE 1000 may include a processor 1002, a memory 1004, a COT sharing module 1008, a transceiver 1010 including a modem subsystem 1012 and a radio frequency (RF) unit 1014, and one or more antennas 1016. These elements may be coupled with each other and in direct or indirect communication with each other, for example via one or more buses. The UE 1000 may be similar to the UE 115i or the UE 115j discussed above with reference to FIG. 3. The COT sharing module 1008 may include LBT logic 306, COT structure scheduler 307, and COT sharing information 308 discussed above with reference to FIG. 3.

The processor 1002 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 1004 includes a non-transitory computer-readable medium. The memory 1004 may store instructions 1006. The instructions 1006 may include instructions that, when executed by the processor 1002, cause the processor 1002 to perform the operations described herein with reference to the UEs 115 in connection with aspects of the present disclosure, for example, aspects of FIGS. 3-9B. Instructions 1006 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The COT sharing module 1008 may be implemented via hardware, software, or combinations thereof. For example, the COT sharing module 1008 may be implemented as a processor, circuit, and/or instructions 1006 stored in the memory 1004 and executed by the processor 1002. Additionally or alternatively, the COT sharing module 1008 can be implemented in any combination of hardware and software, and may, in some implementations, involve, for example, processor 1002, memory 1004, instructions 1006, transceiver 1010, and/or modem 1012. In some aspects, the COT sharing module 1008 may implement the aspects of FIGS. 3-9B. For example, the COT sharing module 1008 may perform a listen-before-talk (LBT) procedure. The COT sharing module 1008 may acquire, based on the LBT procedure being successful, a channel occupancy time (COT). The COT sharing module 1008 may transmit, to a second UE during the COT, COT sharing information for sharing the COT with the second UE.

As shown, the transceiver 1010 may include the modem subsystem 1012 and the RF unit 1014. The transceiver 1010 can be configured to communicate bi-directionally with other devices, such as the BSs 105 and/or the UEs 115. The modem subsystem 1012 may be configured to modulate and/or encode the data from the memory 1004 and the according to a modulation and coding scheme (MCS), e.g., a low-density parity check (LDPC) coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data from the modem subsystem 1012 (on outbound transmissions) or of transmissions originating from another source such as a UE 115 or a BS 105. The RF unit 1014 may be further configured to perform analog beamforming in conjunction with the digital beamforming. Although shown as integrated together in transceiver 1010, the modem subsystem 1012 and the RF unit 1014 may be separate devices that are coupled together to enable the UE 1000 to communicate with other devices.

The RF unit 1014 may provide the modulated and/or processed data, e.g. data packets (or, more generally, data messages that may contain one or more data packets and other information), to the antennas 1016 for transmission to one or more other devices. The antennas 1016 may further receive data messages transmitted from other devices. The antennas 1016 may provide the received data messages for processing and/or demodulation at the transceiver 1010. The antennas 1016 may include multiple antennas of similar or different designs in order to sustain multiple transmission links. The RF unit 1014 may configure the antennas 1016.

In some instances, the UE 1000 can include multiple transceivers 1010 implementing different RATs (e.g., NR and LTE). In some instances, the UE 1000 can include a single transceiver 1010 implementing multiple RATs (e.g., NR and LTE). In some instances, the transceiver 1010 can include various components, where different combinations of components can implement RATs.

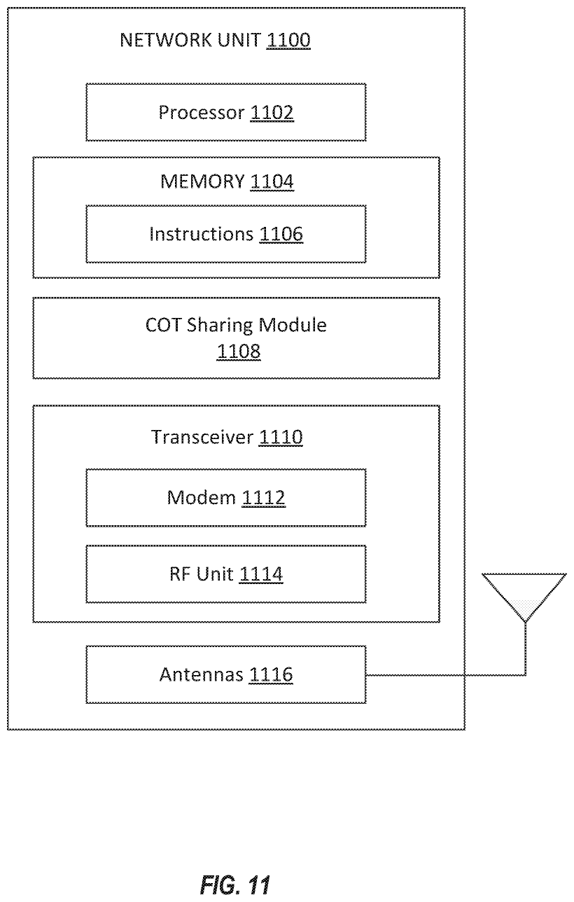

FIG. 11 is a block diagram of an exemplary network unit 1100 according to some aspects of the present disclosure. The network unit 1100 may be a BS 105, the CU 210, the DU 230, or the RU 240, as discussed above. As shown, the network unit 1100 may include a processor 1102, a memory 1104, a COT sharing module 1108, a transceiver 1110 including a modem subsystem 1112 and a RF unit 1114, and one or more antennas 1116. These elements may be coupled with each other and in direct or indirect communication with each other, for example via one or more buses.

The processor 1102 may have various features as a specific-type processor. For example, these may include a CPU, a DSP, an ASIC, a controller, a FPGA device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 1104 may include a non-transitory computer-readable medium. The memory 1104 may store instructions 1106. The instructions 1106 may include instructions that, when executed by the processor 1102, cause the processor 1102 to perform operations described herein, for example, aspects of FIGS. 3-9B. Instructions 1106 may also be referred to as code, which may be interpreted broadly to include any type of computer-readable statement(s).

The COT sharing module 1108 may be implemented via hardware, software, or combinations thereof. For example, the COT sharing module 1108 may be implemented as a processor, circuit, and/or instructions 1106 stored in the memory 1104 and executed by the processor 1102. Additionally or alternatively, the COT sharing module 1108 can be implemented in any combination of hardware and software, and may, in some implementations, involve, for example, processor 1102, memory 1104, instructions 1106, transceiver 1110, and/or modem 1112. In some aspects, the COT sharing module 1108 may implement the aspects of FIGS. 3-9B. For example, the COT sharing module 1108 may performing a listen-before-talk (LBT) procedure. The COT sharing module 1108 may acquire, based on the LBT procedure being successful, a channel occupancy time (COT). The COT sharing module may transmit, to a second UE during the COT, COT sharing information for sharing the COT with the second UE.

As shown, the transceiver 1110 may include the modem subsystem 1112 and the RF unit 1114. The transceiver 1110 can be configured to communicate bi-directionally with other devices, such as the UEs 115. The modem subsystem 1112 may be configured to modulate and/or encode data according to a MCS, e.g., a LDPC coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data from the modem subsystem 1112 (on outbound transmissions) or of transmissions originating from another source such as a UE 115. The RF unit 1114 may be further configured to perform analog beamforming in conjunction with the digital beamforming. Although shown as integrated together in transceiver 1110, the modem subsystem 1112 and/or the RF unit 1114 may be separate devices that are coupled together at the network unit 1100 to enable the network unit 1100 to communicate with other devices.

The RF unit 1114 may provide the modulated and/or processed data, e.g. data packets (or, more generally, data messages that may contain one or more data packets and other information), to the antennas 1116 for transmission to one or more other devices. This may include, for example, a configuration indicating a plurality of sub-slots within a slot according to aspects of the present disclosure. The antennas 1116 may further receive data messages transmitted from other devices and provide the received data messages for processing and/or demodulation at the transceiver 1110. The antennas 1016 may include multiple antennas of similar or different designs in order to sustain multiple transmission links.

In some instances, the network unit 1100 can include multiple transceivers 1110 implementing different RATs (e.g., NR and LTE). In some instances, the network unit 1100 can include a single transceiver 1110 implementing multiple RATs (e.g., NR and LTE). In some instances, the transceiver 1110 can include various components, where different combinations of components can implement RATs.

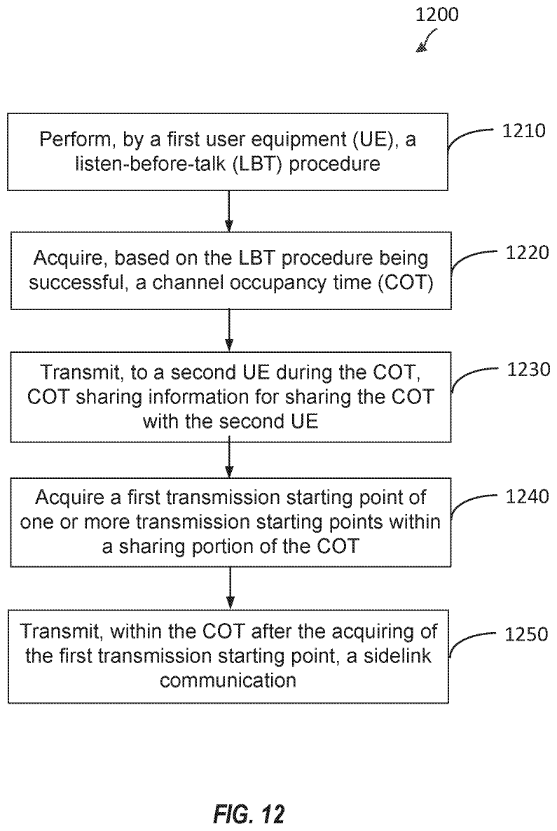

FIG. 12 is a flow diagram of a communication method 1200 according to some aspects of the present disclosure. Aspects of method 1200 can be executed by a computing device (e.g., a processor, processing circuit, and/or other suitable component) of a wireless communication device or other suitable means for performing the aspects. For example, a wireless communication device, such as the UE 115, may utilize one or more components, such as the processor 1002, the memory 1004, the COT sharing module 1008, the transceiver 1010, the modem 1012, and the one or more antennas 1016, to execute aspects of method 1200. The method 1200 may employ similar mechanisms as in the networks 100 and 200 and the aspects and actions described with respect to FIGS. 3-9B. As illustrated, method 1200 includes a number of enumerated aspects, but method 1200 may include additional aspects before, after, and in between the enumerated aspects. In some aspects, one or more of the enumerated aspects may be omitted or performed in a different order.

At action 1210, method 1200 includes a first UE (e.g., UE 115i, UE 1000) performing a listen-before-talk (LBT) procedure. The first UE may perform the LBT procedure or other clear channel assessment (CCA) on one or more SL communication channels. In some instances, the first UE may perform an LBT procedure or other CCA to gain access to a channel occupancy time (COT) in an unlicensed (e.g., shared) frequency spectrum. For example, the first UE may perform a category 1 LBT, a category 2 LBT, a category 3 LBT, and/or a category 4 LBT to gain access to the COT in an unlicensed frequency spectrum. In some aspects, the first UE may perform the LBT in one or more time resources, spatial resources, and/or frequency resources. The frequency resources may include a frequency spectrum, a frequency band, a frequency sub-band, a frequency subchannel, resource elements, resource blocks, and/or a frequency interlace. The time resources may include slot(s), sub-slot(s), symbol(s), subframe(s), or any other suitable time resources. In some aspects, the first UE may perform the LBT for one or more directional beams (e.g., a beam in the direction of the UE that the first UE intends to transmit a communication to and/or receive a communication from).

At action 1220, method 1200 includes the first UE acquiring a channel occupancy time (COT) based on the LBT procedure at action 1210 being successful. The first UE may acquire the COT to transmit a communication to another UE or transmit other communications. Additionally or alternatively, the first UE may share the COT with other UEs.

At action 1230, method 1200 includes the first UE transmitting COT sharing information to a second UE (e.g., UE 115j, UE 1000) for sharing the COT with the second UE. The first UE may transmit the COT sharing information to the second UE during the COT. The COT sharing information may include a COT resource allocation that indicates resources the second UE may use to share the COT. In some aspects, the first UE may transmit the COT sharing information to the second UE and other UEs (e.g., a group of UEs, a set of UEs). The first UE may transmit the COT sharing information including resource allocations to the set of UEs to share the COT with the set of UEs.

In some aspects, the first UE may transmit the COT sharing information via COT-structure information (COT-SI), sidelink control information (e.g., SCI-1, SCI-2), an RRC message, a PSCCH message, a PSSCH message, or other suitable communication. For example, the first UE may transmit the COT sharing information in a SL_COT_SharingInformation field via sidelink control information 2 (SCI-2).

In some aspects, the COT sharing information may include information (e.g., parameters, resources, settings, commands, etc.) to enable the first UE to share the COT with other UEs (e.g., the second UE). Sharing the COT with other UEs may enable the other UEs to transmit and/or receive communications during the COT in an efficient and coordinated fashion. In some aspects, the COT sharing information may include identifiers associated with the set of UEs that share the COT. The UE identifiers may include layer one identifiers unique to each UE that shares the COT.

In some aspects, the COT sharing information may include a time resource allocation associated with the COT sharing. For example, the time resource allocation may include a COT start time, a COT end time, and/or a COT duration. The time resource allocation may include time resources (e.g., slots, sub-slots, symbols, frames, etc.) allocated to the set of UEs that share the COT. For example, the time resource allocation may indicate index(s) indicating starting slot(s) and/or sub-slot(s) allocated to the set of UEs. The time resource allocation may indicate a number of time resources (e.g., a number of slots, sub-slots, and/or symbols) allocated to the set of UEs. The first UE may indicate the time resource allocation(s) to the UEs sharing the COT in a time domain resource allocation (TDRA) via SCI-1.

In some aspects, the COT sharing information may include a frequency resource allocation (e.g., frequency range(s)) associated with the COT sharing. For example, the frequency resource allocation may include a starting frequency (e.g., a starting frequency subchannel index, a starting frequency band, a starting frequency interlace). The frequency resource allocations may include an ending frequency (e.g., an ending subchannel, an ending frequency band). The frequency resource allocations may include a frequency interlace (e.g., a frequency interlace index, indexes of subchannels). The frequency resource allocation may indicate frequency resources allocated to the set of UEs that share the COT with the first k UE. The first UE may indicate the frequency resource allocation(s) to the UEs sharing the COT in a frequency domain resource allocation (FDRA) via SCI-1.

In some aspects, the first UE may transmit a flag indicating the first UE is sharing the COT. In this regard, the first UE may transmit the flag to one or more other UEs via SCI (e.g., SCI-1, SCI-2) indicating the first UE is sharing the COT. The flag may include a single bit (e.g., 0 or 1) indicator, a multi-bit indicator, a code point, or other indicator to indicate the other UE(s) (e.g., the UE(s) receiving the flag) may share the COT.

In some aspects, the first UE may transmit the flag to the UE(s) in SCI-2 via a PSSCH. The SCI-2 may include destination identifier(s) associated with the second UE and/or other UEs indicating the first UE shares the COT with the second UE and/or the other UEs. In some instances, the UEs in proximity to the first UE that receive and decode the SCI-2 may share the COT with the first UE if the SCI-2 includes an identifier that matches the identifier associated with the receiving UEs.

In some aspects, the COT sharing information may indicate a groupcast identifier associated with a set of UEs for sharing the COT with the first UE. In this regard, the first UE may transmit the COT sharing information via SCI-2. The SCI-2 may include a groupcast identifier that indicates the set of UEs including the second UE that may share the COT.

In some aspects, COT sharing information may indicate a group of transmission starting points (TSPs). In some implementations, each of the TSPs may have the same priority. In some implementations, the TSPs may have priorities associated with a channel access priority class (CAPC). The COT sharing information indicating the TSPs may include a lookup table mapping a TSP index to TSP(s), a channel access priority class (CAPC), an LBT category type, and/or a CPE. For example, the lookup table may include one or more TSP entries that corresponds to a CAPC. In some aspects, each of the TSP(s) may correspond to a different CAPC. In some aspects, multiple TSPs may correspond to the same CAPC. In some aspects, the same TSP may correspond to multiple CAPCs. The CAPC may be associated with an SL communication. The SL communication may be a transport block transmitted via a PSSCH. The CAPC associated with the SL communication may indicate the priority (e.g., latency budget) of the SL communication. In some aspects, a higher CAPC value (e.g., 4) may indicate a lower priority level while a lower CAPC value (e.g., 1) may indicate a higher priority level. In some implementations, an early TSP (e.g., the first TSP) may be exclusively reserved to the UE that initiated the COT (e.g., the first UE).

At action 1240, the method 1200 includes the first UE acquiring one of the TSPs within the shared COT. The first UE may acquire the TSP without advantage in a contending process or with advantage assigned (e.g., through priority or reservation).

At action 1250, the method 1200 includes the first UE transmitting an SL communication in the resources starting with the acquired (or reserved) TSP. For example, the first UE may transmit during the cyclic prefix extension (CPE) between the TSP and the slot boundary (e.g., the boundary between the end of symbol 13 and symbol 0 of the next slot). By transmitting during the CPE starting at the TSP, the first UE may block other UEs contending for the shared COT. The transmission length may be within the slot following the TSP or consecutive multiple slots following the TSP until the SL communication is over.

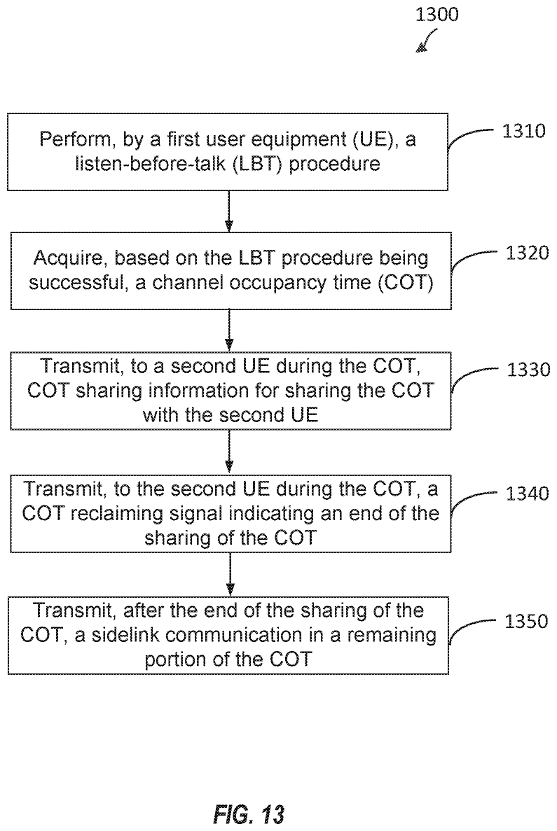

FIG. 13 is a flow diagram of a communication method 1300 according to some aspects of the present disclosure. Some of the actions of method 1300 are similar to those of method 1200, some of the details are being omitted for sake of brevity and that the corresponding actions of method 1200 can be reviewed for the additional details.

Aspects of method 1300 can be executed by a computing device (e.g., a processor, processing circuit, and/or other suitable component) of a wireless communication device or other suitable means for performing the aspects. For example, a wireless communication device, such as the UE 115, may utilize one or more components, such as the processor 1002, the memory 1004, the COT sharing module 1008, the transceiver 1010, the modem 1012, and the one or more antennas 1016, to execute aspects of method 1300. The method 1300 may employ similar mechanisms as in the networks 100 and 200 and the aspects and actions described with respect to FIGS. 3-9B. As illustrated, method 1300 includes a number of enumerated aspects, but method 1300 may include additional aspects before, after, and in between the enumerated aspects. In some aspects, one or more of the enumerated aspects may be omitted or performed in a different order.

At action 1310, method 1300 includes a first UE (e.g., UE 115i, UE 1000) performing a listen-before-talk (LBT) procedure. The first UE may perform the LBT procedure or other clear channel assessment (CCA) on one or more SL communication channels. In some instances, the first UE may perform an LBT procedure or other CCA to gain access to a channel occupancy time (COT) in an unlicensed (e.g., shared) frequency spectrum. For example, the first UE may perform a category 1 LBT, a category 2 LBT, a category 3 LBT, and/or a category 4 LBT to gain access to the COT in an unlicensed frequency spectrum. In some aspects, the first UE may perform the LBT in one or more time resources, spatial resources, and/or frequency resources. The frequency resources may include a frequency spectrum, a frequency band, a frequency sub-band, a frequency subchannel, resource elements, resource blocks, and/or a frequency interlace. The time resources may include slot(s), sub-slot(s), symbol(s), subframe(s), or any other suitable time resources. In some aspects, the first UE may perform the LBT for one or more directional beams (e.g., a beam in the direction of the UE that the first UE intends to transmit a communication to and/or receive a communication from).

At action 1320, method 1300 includes the first UE acquiring a channel occupancy time (COT) based on the LBT procedure at action 1310 being successful. The first UE may acquire the COT to transmit a communication to another UE or transmit other communications. Additionally or alternatively, the first UE may share the COT with other UEs.

At action 1330, method 1300 includes the first UE transmitting COT sharing information to a second UE (e.g., UE 115j, UE 1000) for sharing the COT with the second UE. The first UE may transmit the COT sharing information to the second UE during the COT. The COT sharing information may include a COT resource allocation that indicates resources the second UE may use to share the COT. In some aspects, the first UE may transmit the COT sharing information to the second UE and other UEs (e.g., a group of UEs, a set of UEs). The first UE may transmit the COT sharing information including resource allocations to the set of UEs to share the COT with the set of UEs.

In some aspects, the first UE may transmit the COT sharing information via COT-structure information (COT-SI), sidelink control information (e.g., SCI-1, SCI-2), an RRC message, a PSCCH message, a PSSCH message, or other suitable communication. For example, the first UE may transmit the COT sharing information in a SL_COT_SharingInformation field via sidelink control information 2 (SCI-2).

In some aspects, the COT sharing information may include information (e.g., parameters, resources, settings, commands, etc.) to enable the first UE to share the COT with other UEs (e.g., the second UE). Sharing the COT with other UEs may enable the other UEs to transmit and/or receive communications during the COT in an efficient and coordinated fashion. In some aspects, the COT sharing information may include identifiers associated with the set of UEs that share the COT. The UE identifiers may include layer one identifiers unique to each UE that shares the COT.

In some aspects, the COT sharing information may include a time resource allocation associated with the COT sharing. For example, the time resource allocation may include a COT start time, a COT end time, and/or a COT duration. The time resource allocation may include time resources (e.g., slots, sub-slots, symbols, frames, etc.) allocated to the set of UEs that share the COT. For example, the time resource allocation may indicate index(s) indicating starting slot(s) and/or sub-slot(s) allocated to the set of UEs. The time resource allocation may indicate a number of time resources (e.g., a number of slots, sub-slots, and/or symbols) allocated to the set of UEs. The first UE may indicate the time resource allocation(s) to the UEs sharing the COT in a time domain resource allocation (TDRA) via SCI-1.

In some aspects, the COT sharing information may include a frequency resource allocation (e.g., frequency range(s)) associated with the COT sharing. For example, the frequency resource allocation may include a starting frequency (e.g., a starting frequency subchannel index, a starting frequency band, a starting frequency interlace). The frequency resource allocations may include an ending frequency (e.g., an ending subchannel, an ending frequency band). The frequency resource allocations may include a frequency interlace (e.g., a frequency interlace index, indexes of subchannels). The frequency resource allocation may indicate frequency resources allocated to the set of UEs that share the COT with the first UE. The first UE may indicate the frequency resource allocation(s) to the UEs sharing the COT in a frequency domain resource allocation (FDRA) via SCI-1.

In some aspects, the first UE may transmit a flag indicating the first UE is sharing the COT. In this regard, the first UE may transmit the flag to one or more other UEs via SCI (e.g., SCI-1, SCI-2) indicating the first UE is sharing the COT. The flag may include a single bit (e.g., 0 or 1) indicator, a multi-bit indicator, a code point, or other indicator to indicate the other UE(s) (e.g., the UE(s) receiving the flag) may share the COT.

In some aspects, the first UE may transmit the flag to the UE(s) in SCI-2 via a PSSCH. The SCI-2 may include destination identifier(s) associated with the second UE and other UEs indicating the first UE shares the COT with the second UE and/or the other UEs. In some instances, the UEs in proximity to the first UE that receive and decode the SCI-2 may share the COT with the first UE if the SCI-2 includes an identifier that matches the identifier associated with the receiving UEs.

In some aspects, the COT sharing information may indicate a groupcast identifier associated with a set of UEs for sharing the COT with the first UE. In this regard, the first UE may transmit the COT sharing information via SCI-2. The SCI-2 may include a groupcast identifier that indicates the set of UEs including the second UE that may share the COT.

At action 1340, the method 1300 includes the first UE transmitting a COT reclaiming signal. The COT reclaiming signal reverts remaining portion of the shared COT to a reserved status. After receiving the COT reclaiming signal, other UEs refrain from accessing the remaining portion of the COT. After reverting the remaining portion of the shared COT to a reserved COT, the first UE may transmit communications in the remaining portion of the COT without risks of collision with other contending UEs.

In some aspects, the COT reclaiming signal be a flag signal that indicates the end of the current slot containing the COT reclaiming signal as the end of the shared COT. Alternatively, the COT reclaiming signal may indicate the end of the sharing of the COT is offset by one or more slots from a current slot containing the COT reclaiming signal. The COT reclaiming signal may define amount of slots as offset.

In some aspects, the COT reclaiming signal may be transmitted via a COT-SI, SCI-1, SCI-2, or information contained in PSFCH (e.g., using other formats than PFO). In some aspects, to function as a flag signal that indicates the end of the current slot as the end of the shared COT, the COT reclaiming signal may be transmitted as a PSFCH mapped to one of the initiating UE's transmissions when HARQ Feedback is disabled to implicitly indicate that the previously-shared COT is reclaimed.

At action 1350, the method 1300 includes the first UE transmitting an SL communication in the resources starting with the acquired (or reserved) TSP. For example, the first UE may transmit during the cyclic prefix extension (CPE) between the TSP and the slot boundary (e.g., the boundary between the end of symbol 13 and symbol 0 of the next slot). By transmitting during the CPE starting at the TSP, the first UE may block other UEs contending for the shared COT. The transmission length may be within the slot following the TSP or consecutive multiple slots following the TSP until the SL communication is over.

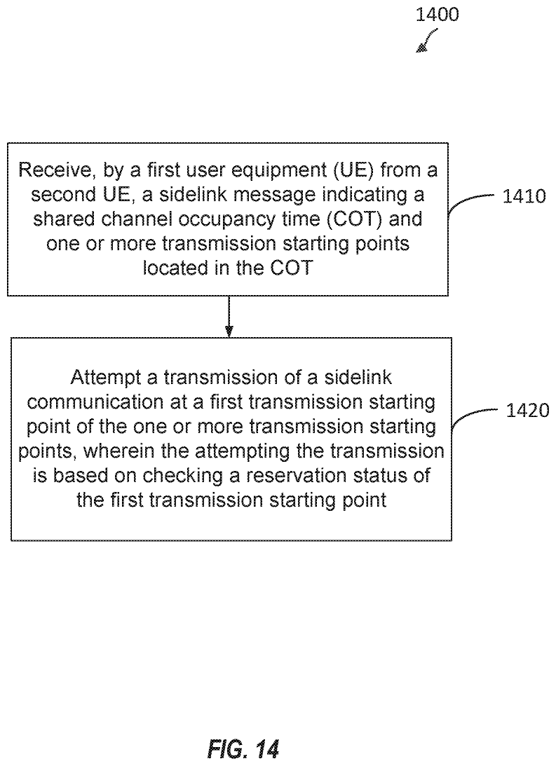

FIG. 14 is a flow diagram of a communication method 1400 according to some aspects of the present disclosure. Aspects of the method 1400 can be executed by a computing device (e.g., a processor, processing circuit, and/or other suitable component) of a wireless communication device or other suitable means for performing the aspects. For example, a wireless communication device, such as the UE 115, may utilize one or more components, such as the processor 1002, the memory 1004, the COT sharing module 1008, the transceiver 1010, the modem 1012, and the one or more antennas 1016, to execute aspects of method 1400. The method 1200 may employ similar mechanisms as in the networks 100 and 200 and the aspects and actions described with respect to FIGS. 3-9B. As illustrated, the method 1400 includes a number of enumerated aspects, but the method 1400 may include additional aspects before, after, and in between the enumerated aspects. In some aspects, one or more of the enumerated aspects may be omitted or performed in a different order.

At action 1410, the method 1400 includes a first UE (e.g., UE 115j) receiving from a second UE (e.g., UE 115i) an SL message indicating a shared channel occupancy time (COT) and one or more TSPs located in the COT. Aspects of action 1410 may be similar to action 1230 of method 1200 or action 130 of method 1300, but from the perspective of a responding UE.

At action 1420, the method 1400 includes the first UE attempting a transmission of an SL communication at one of the TSPs, where the attempting the transmission is based on checking a reservation status of the one of the TSPs. The reservation status may be indicated in COT sharing information received from the second UE. The first UE may completely refrain from accessing any of the TSPs if one of the TSPs has been reserved by the second UE. Alternatively, the first UE may access subsequent TSPs only after detecting that the second UE is not using the reserved TSP. Alternatively, to better utilize the shared spectrum, the first UE may transmit an SL communication in an FDM with the second UE.

Further aspects of the present disclosure include the following:
Aspect 1 includes a method of wireless communication performed by a first user equipment (UE), the method comprising performing a listen-before-talk (LBT) procedure; acquiring, based on the LBT procedure being successful, a channel occupancy time (COT); transmitting, to a second UE during the COT, a sidelink message for informing the second UE of a shared portion of the COT; acquiring a first transmission starting point of one or more transmission starting points within a remaining portion of the COT; and transmitting, within the COT after the acquiring of the first transmission starting point, a sidelink communication.
Aspect 2 includes the method of aspect 1, wherein the acquiring the first transmission starting point comprises competing with at least the second UE for the first transmission starting point of the one or more transmission starting points.
Aspect 3 includes the method of any of aspects 1-2, wherein the competing for the first transmission starting point of the one or more transmission starting points includes performing a channel access procedure.
Aspect 4 includes the method of any of aspects 1-3, wherein a type of the channel access procedure is based on a gap between the first transmission starting point of the one or more transmission starting points and an end of a previous transmission in the COT.
Aspect 5 includes the method of any of aspects 1-4, wherein the previous transmission is the transmitting the COT sharing information.
Aspect 6 includes the method of any of aspects 1-5, wherein the previous transmission is a latest transmission from the first UE.
Aspect 7 includes the method of any of aspects 1-6, wherein the previous transmission is a latest transmission from the second UE.
Aspect 8 includes the method of any of aspects 1-7, wherein the first UE has priority over the second UE in acquiring the first transmission starting point of the one or more transmission starting points.
Aspect 9 includes the method of any of aspects 1-8, wherein the first UE has priority over the second UE based on a channel access priority class (CAPC).
Aspect 10 includes the method of any of aspects 1-9, wherein the first transmission starting point is solely reserved for the first UE.
Aspect 11 includes the method of any of aspects 1-10, wherein the first transmission starting point is an initial transmission starting point of the one or more transmission starting points.
Aspect 12 includes the method of any of aspects 1-11, wherein the first transmission starting point of the one or more transmission starting points is located in a gap symbol of a slot.
Aspect 13 includes the method of any of aspects 1-12, wherein the acquiring the first transmission starting point is achieved vias cyclic prefix extension.
Aspect 14 includes the method of any of aspects 1-13, wherein the first transmission starting point of the one or more transmission starting points is located in an automatic gain control (AGC) symbol of a slot.
Aspect 15 includes the method of any of aspects 1-14, wherein the acquiring the first transmission starting point is achieved vias AGC symbol puncturing.
Aspect 16 includes the method of any of aspects 1-15, wherein the transmitting the COT sharing information includes transmitting indication of the one or more transmission starting points.
Aspect 17 includes the method of any of aspects 1-16, wherein the transmitting indication of the one or more transmission starting points includes transmitting sidelink control information (SCI) that contains the indication of the one or more transmission starting points.
Aspect 18 includes the method of any of aspects 1-17, wherein indication of the one or more transmission starting points is provided in sidelink control information (SCI) of the COT.
Aspect 19 includes a method of wireless communication performed by a first user equipment (UE), the method comprising performing a listen-before-talk (LBT) procedure; acquiring, based on the LBT procedure being successful, a channel occupancy time (COT); transmitting, to a second UE during the COT, COT sharing information for sharing the COT with the second UE; transmitting, to the second UE during the COT, a COT reclaiming signal indicating an end of the sharing of the COT; and transmitting, after the end of the sharing of the COT, a sidelink communication in a remaining portion of the COT.
Aspect 20 includes the method of aspect 19, wherein the COT reclaiming signal indicates the end of the sharing of the COT is at an end of a current slot containing the COT reclaiming signal.
Aspect 21 includes the method of any of aspects 19-20, wherein the COT reclaiming signal indicates the end of the sharing of the COT is offset by one or more slots from a current slot containing the COT reclaiming signal.
Aspect 22 includes the method of any of aspects 19-21, wherein the transmitting the COT reclaiming signal comprises transmitting the COT reclaiming signal in sidelink control information (SCI).
Aspect 23 includes the method of any of aspects 19-22, wherein the transmitting the COT reclaiming signal comprises transmitting the COT reclaiming signal in a physical sidelink feedback channel (PSFCH).
Aspect 24 includes a method of wireless communication performed by a first user equipment (UE), the method comprising receiving, from a second UE, a sidelink message indicating a shared portion of a channel occupancy time (COT); select a first transmission starting point of one or more transmission starting points within the COT, based on a reservation status of the first transmission starting point; and attempting a transmission of a sidelink communication after performing an LBT procedure, based at least in part on an outcome of the LBT procedure.
Aspect 25 includes the method of aspect 24, wherein the attempting the transmission is refrained from the first transmission starting point and rest of the one or more transmission starting points when the first transmission starting point is reserved by the second UE.
Aspect 26 includes the method of any of aspects 24-25, wherein the attempting the transmission is moved to a second transmission starting point of the one or more transmission starting points when the first transmission starting point is reserved by the second UE, wherein the second transmission starting point is after the first transmission starting point.
Aspect 27 includes the method of any of aspects 24-26, wherein the transmission is performed by the first UE when no accessing to the first transmission starting point by the second UE is detected by the first UE.
Aspect 28 includes the method of any of aspects 24-27, wherein the attempting the transmission is moved to a second transmission starting point of the one or more transmission starting points when the first transmission starting point is reserved by the second UE and the first UE is not a target recipient of the second UE by reserving the first transmission starting point, wherein the second transmission starting point is after the first transmission starting point.
Aspect 29 includes the method of any of aspects 24-28, wherein the transmission of the sidelink communication is performed by the first UE in a frequency division multiplex (FDM) at the first transmission starting point when the first transmission starting point is reserved by the second UE and the sidelink communication is not a unicast to the second UE.
Aspect 30 includes the method of any of aspects 24-29, wherein the sidelink communication is one of a groupcast of a broadcast to a plurality of UEs.
Aspect 31 includes the method of any of aspects 24-30, wherein the transmission of the sidelink communication is performed by the first UE in a frequency division multiplex (FDM) at the first transmission starting point when the first transmission starting point is reserved by the second UE for one or more target recipients other than the first UE and the sidelink communication is not a unicast to the second UE.
Aspect 32 includes a non-transitory computer-readable medium storing one or more instructions for wireless communication, the one or more instructions comprising one or more instructions that, when executed individually or collectively by one or more processors of a UE, cause the UE to perform any one of aspects 1-18.
Aspect 33 includes a non-transitory computer-readable medium storing one or more instructions for wireless communication, the one or more instructions comprising one or more instructions that, when executed individually or collectively by one or more processors of a UE, cause the UE to perform any one of aspects 19-23.
Aspect 34 includes a non-transitory computer-readable medium storing one or more instructions for wireless communication, the one or more instructions comprising one or more instructions that, when executed individually or collectively by one or more processors of a UE, cause the UE to perform any one of aspects 24-31.
Aspect 35 includes a user equipment (UE) comprising one or more means to perform any one or more of aspects 1-18.
Aspect 36 includes a user equipment (UE) comprising one or more means to perform any one or more of aspects 19-23.
Aspect 37 includes a user equipment (UE) comprising one or more means to perform any one or more of aspects 24-31.
Aspect 38 includes a user equipment (UE) comprising one or more means to perform any one or more of aspects 1-18.
Aspect 39 includes a user equipment (UE) comprising one or more means to perform any one or more of aspects 19-23.
Aspect 40 includes a user equipment (UE) comprising one or more means to perform any one or more of aspects 24-31.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents. This listing of claims will replace all prior versions, and listings, of claims in the application:

1. A user equipment (UE) comprising:
a memory;
a transceiver; and
one or more processors coupled to the memory and the transceiver, the memory comprising instructions executable by the one or more processors individually or collectively to cause the UE to:
perform a listen-before-talk (LBT) procedure;
acquire, based on the LBT procedure being successful, a channel occupancy time (COT);
transmit, to a second UE during the COT, a sidelink message for informing the second UE of a shared portion of the COT;
acquire a first transmission starting point of one or more transmission starting points within a remaining portion of the COT; and
transmit, within the COT after the acquiring of the first transmission starting point, a sidelink communication.

2. The UE of claim 1, wherein the acquiring the first transmission starting point of the one or more transmission starting points is within the shared portion of the COT.

3. The UE of claim 1, wherein the acquiring the first transmission starting point of the one or more transmission starting points includes performing a channel access procedure.

4. The UE of claim 3, wherein a type of the channel access procedure is based on a gap between the first transmission starting point of the one or more transmission starting points and an end of a previous transmission in the COT.

5. The UE of claim 4, wherein the previous transmission is a latest transmission from the first UE.

6. The UE of claim 4, wherein the previous transmission is a latest transmission from the second UE.

7. The UE of claim 3, wherein the first UE has priority over the second UE in acquiring the first transmission starting point of the one or more transmission starting points.

8. The UE of claim 7, wherein the first UE has priority over the second UE based on a channel access priority class (CAPC).

9. The UE of claim 7, wherein the first UE has priority over the second UE based on an L-1 priority of the sidelink communication.

10. The UE of claim 1, wherein the acquiring the first transmission starting point of one or more transmission starting points within the remaining portion of the COT is based at least in part on any gap between any two transmissions in the COT being smaller than a pre-defined value.

11. The UE of claim 1, wherein the first transmission starting point is reserved for the first UE.

12. The UE of claim 11, wherein the first transmission starting point is an initial transmission starting point of the one or more transmission starting points.

13. The UE of claim 1, wherein the acquiring the first transmission starting point is achieved vias cyclic prefix extension.

14. The UE of claim 1, wherein the transmitting the sidelink message includes transmitting indication of the one or more transmission starting points.

15. A user equipment (UE) comprising:
a memory;
a transceiver; and
one or more processors coupled to the memory and the transceiver, the memory comprising instructions executable by the one or more processors individually or collectively to cause the UE to:
receive, from a second UE, a sidelink message indicating a shared portion of a channel occupancy time (COT);
select a first transmission starting point of one or more transmission starting points within the COT, based on a reservation status of the first transmission starting point; and
attempt a transmission of a sidelink communication after performing an LBT procedure, based at least in part on an outcome of the LBT procedure.

16. The UE of claim 15, wherein the attempting the transmission is refrained from the first transmission starting point and rest of the one or more transmission starting points when the first transmission starting point is reserved by the second UE.

17. The UE of claim 15, wherein the attempting the transmission is moved to a second transmission starting point of the one or more transmission starting points when the first transmission starting point is reserved by the second UE, wherein the second transmission starting point is after the first transmission starting point.

18. The UE of claim 15, wherein the transmission of the sidelink communication is performed by the first UE at the first transmission starting point when the first transmission starting point is reserved by the second UE and the sidelink communication is not a unicast to the second UE.

19. The UE of claim 18, wherein the transmission of the sidelink communication is performed by the first UE in a frequency division multiplex (FDM) at the first transmission starting point.

20. (canceled)

21. A method of wireless communications performed by a first user equipment (UE), the method comprising:
performing a listen-before-talk (LBT) procedure;
acquiring, based on the LBT procedure being successful, a channel occupancy time (COT);
transmitting, to a second UE during the COT, a sidelink message for informing the second UE of a shared portion of the COT;
acquiring a first transmission starting point of one or more transmission starting points within a remaining portion of the COT; and
transmitting, within the COT after the acquiring of the first transmission starting point, a sidelink communication.

22-30. (canceled)
